(19) United States
(12) Patent Application Publication
(10) Pub. No.: US 2015/0353832 A1
(43) Pub. Date: Dec. 10, 2015

(54) PHOSPHINATE IONIC LIQUID COMPOSITIONS AND METHODS OF USE

(71) Applicant: H & C Scientific Resources International, LLC, Longmont, CO (US)

(72) Inventor: Yanjie Xu, Longmont, CO (US)

(73) Assignee: H & C Scientific Resources International, LLC, Longmont, CO (US)

(21) Appl. No.: 14/158,790

(22) Filed: Jan. 18, 2014

Related U.S. Application Data
(60) Provisional application No. 61/758,325, filed on Jan. 30, 2013.
(60) Provisional application No. 61/844,938, filed on Jul. 11, 2013.
(60) Provisional application No. 61/889,577, filed on Oct. 11, 2013.

(51) Int. Cl. C09K 21/12; D21H 17/10; C14C 9/00; C08K 5/5313

(52) U.S. Cl. CPC C09K 21/12; C08K 5/5313; D21H 17/10; C14C 9/00

(57) ABSTRACT

The present invention relates to the use of phosphinate ionic liquids as flame retardants and also as a melt reduction agent for polymer processing. The compounds of the invention may be used as flame retardants in various materials without causing damage to the environment and or health of humans or animals. Ionic liquid flame retardants maybe applied alone or in combination with traditional flame retardants. Ionic liquid flame retardants can be applied to finish textile, plastic, leather, paper, rubber or as wild fire flame retardants.

### CROSS REFERENCE TO RELATED APPLICATIONS

This application claims the benefit of U.S. Provisional Application No. 61/758,325, filed on Jan. 30, 2013, U.S. Provisional Application No. 61/844,938, filed on Jul. 11, 2013 and U.S. Provisional Application No. 61/889,577 filed on Oct. 11, 2013, all of which are incorporated herein in their entirety.

### FIELD OF THE INVENTION

The present invention is broadly directed to novel flame or fire retardant compositions and polymer melt viscosity reduction agents and crystallization enhancement agents, including phosphinate ionic liquids.

### BACKGROUND OF THE INVENTION

Flame retardants are chemical additives which may be used across a variety of consumer products, such as plastics, textiles, leather, paper, rubber, etc. Chemicals which may be used as flame retardants can be mineral, halogen containing, nitrogen containing and phosphorus containing chemicals, silicon based chemicals, etc. The term “retardant” represents a class of use and not a class of chemical structure.

Fundamentally, four processes are involved in polymer flammability: preheating, decomposition, ignition and combustion and propagation. Flame retardants interfere with combustion during a particular stage of this process, i.e. during heating, decomposition, ignition or flame spread through physical or chemical actions.

Flame retardants may impede combustion by providing chemical reactions which interfere with combustion processes occurring in the solid and/or gas phases. For reactions in the gas phase, a free radical mechanism of a combustion process which takes place in the gas phase is interrupted by a flame retardant. Exothermic processes may thus be stopped, the system cools down, and the supply of flammable gases is reduced and eventually completely suppressed. For reactions in the solid phase, two types of reaction may take place. Firstly, breakdown of a polymer may be accelerated by a flame retardant, causing pronounced flow of a polymer and, hence, its withdrawal from the sphere of influence of the flame, which breaks away. Secondly, a flame retardant may cause a layer of carbon to form on a polymer surface.

In recent years, there are growing concerns about the safety of these flame retardant chemicals. An issue with the above mentioned forest flame retarding chemicals are their impact on the environment. Brominated flame retardants, such as polybrominated diphenylethers (PBDEs), were first introduced into the consumer marketplace in the 1970s. They showed great compatibility with plastics and textiles, and offered superior flame retardant properties. The most commonly used brominated flame retardants are PBDEs and tetrabromobisphenol A (TBBPA).

Great efforts are being put into developing halogen free flame retardants, especially phosphorus based flame retardants. However, their flame retarding performance is not satisfactory. The prior art describes the use of some phosphonium ion salts. Doring et al describe polyphosphonium cations with selected anions as flame retardants in application US20100160476. Japanese patent application JP 2010163396 describes straight chain alkylaryl phosphonium salt structures as polymer dopants for high conductivity, heat resistance and flame retardancy. Tan et al, Faming Shuanli Shenqing Gongkai Shuomingshu, CAPLUS AN 2010:740737 (Patent), Jun. 9, 2010, reported fireproofing agent containing quaternary phosphonium salt-modified montmorillonite as flame retardants. A review by Guo et al, Zhongguo Pige, 2004, CAPLUS AN 2005:551561 describes development and applications of tetrakis(hydroxymethyl) phosphonium salts as flame retardants for textiles, leather tanning agents, bactericides for wastewater treatment, among other applications. Ammonium surfactants have been employed to modify the surface of nanoclays for flame retarding applications.

Metal salts of dialkyl phosphinates are known to be effective flame retardants since the late 1970s. Clariant investigated a wide spectrum of zinc, aluminum and calcium salts of dialkyl phosphinates as flame retardants. Aluminium diethyl phosphinates that were originally developed for glass-fibre reinforced polyamides and polyester achieved UL 94-V0 rating in with ˜40 wt % additive. Clariant initiated the production of aluminium salts of diethyl phosphinate, which are commercially available under the brand name Exolit OP 930 and Exolit OP 935. They now find commercially promising application in PWB.

Some of the key aspects of metal phosphinates are their high phosphorus content (˜17%), good thermal stability (up to 320° C.) and lower affinity to moisture. Hydrolytic stability is especially important, since the release of phosphoric acids is not tolerated during extrusion or lead-free soldering because of acidic degradation. Schartel et al. investigated aluminium diethyl phosphinates (w/o melamine cyanurate as a synergist) as a flame retardant for polyesters (w/o glass-fibre). The results indicate that diethyl phosphinic acid is released in the gas phase during the decomposition of the polymer. UL 94-V0 rating could be achieved with a combined flame retardant loading of 20 wt %. It has been reported that metal phosphinates are most effective in combination with a nitrogen synergist, such as melamine polyphosphate (MPP).

Those traditional metal salts of phosphinate as flame retardants also have theirs inherent drawbacks. One is the metal cation, which is not comparable with plastics materials; the other is one aluminum cation coming with three phosphinate anions, therefore the overall molecules is relatively large. As a result, the compatibility of metal phosphinate salts is relatively limited. Additionally, the final physical-mechanical properties of the treated materials would be affected.

The phosphinate ionic liquids (ILs) of the present application may be used as flame retardants that can bring several advantages that the traditional metal phosphinate salts cannot. One is the organic ionic nature of the molecules, which will have better solvating power towards materials to be treated. Therefore, effects on the mechanical physical properties of the treated materials will be minimal. At the same time, the ILs of the present application have superior solvating power towards many inorganic and organic molecules. Therefore, it can form more uniform distribution with inorganic or organic synergist or co-flame retardants. More important, the flame retardant will be liquid at the processing temperature, which will add up to that easy processing and compatibility of the phosphinate IL flame retardants. Additionally, more functions can be added through choosing the right cation or functionalizing the cations. For example, hydroxyl group added at the cations can form hydrogen bond with some plastic materials, and help to form a uniform distribution of the flame retardants in the plastic materials.

The phosphinate IL flame retardants of the present application can be used in plastics, textiles, rubber, feather, paper, wood, etc. Additionally, the ILs can also be used as flame retarding spray, flame retarding paint. The ILs can also be used as flame retarding plasticizers, to be used in plastics and dry walls.

The foregoing examples of the related art and limitations are intended to be illustrative and not exclusive. Other limitations of the related art will become apparent to those of skill in the art upon a reading of the specification and a study of the drawings or figures as provided herein.

### SUMMARY OF THE INVENTION

Therefore a continuing need exists for flame retardant compounds that are environmentally benign and nonmigrating. Ionic liquids show excellent resistance to migration and leaching and do not accumulate in fatty tissue causing toxicity. Additionally, incorporating biodegradable groups can make ionic liquids ready biodegradable and completely non-toxic. The following embodiments, aspects and variations thereof are exemplary and illustrative and not intended to be limiting in scope.

In one embodiment, there is provided a method for preparing a flame retardant material comprising contacting or formulating the material with a flame retarding composition comprising an ionic liquid compound of the formula 1:

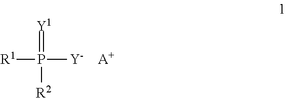

wherein:

Y and Y¹ are each independently selected from O or S;

R¹ and R² are each independently selected from the group consisting of hydrogen, (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group, each of which may be unsubstituted or substituted with one or two halo, —NO₂, CF₃—, CF₃O—, CH₃O—, —CO₂H, —NH₂, —OH, —SH, —NHCH₃, —N(CH₃)₂, —CN, —SMe, —SO₃H, —CH═CH₂, —CH₂CH═CH₂, —P((C₁-C₅)alkyl)₂ and —P(O)(OEt)₂, or mixtures of the substituents;

A⁺ is a cation selected from the group consisting of an ammonium, imidazolium, guanidinium, pyridinium, pyridazinium, 1,2,4-triazolium, triazine, sulfonium, phosphazenium and phosphonium cation; and optionally, wherein the A⁺ is a cation as defined above that is covalently bonded to a polymer. In one variation, Y and Y¹ are both O.

In one aspect of the above ionic liquid, the cation may be covalently bonded to a polymer by way of a covalent bond to the ammonium, imidazolium, guanidinium, pyridinium, pyridazinium, 1,2,4-triazolium, triazine, sulfonium, phosphazenium and phosphonium cation, or bonded to a substituent on the ammonium, imidazolium, guanidinium, pyridinium, pyridazinium, 1,2,4-triazolium, triazine, sulfonium, phosphazenium and phosphonium cation. In one aspect of the above, these IL do not include a combination or a mixture of zinc and aluminum phosphinates. In one aspect of the above, the phosphinate ionic liquid (IL) is selected from trihexyltetradecylphosphonium bis(2,4,-trimethylpentyl)phosphinate and trihexyl(tetradecyl)phosphonium bis-2,4,4-(trimethylpentyl)phosphinate. In another aspect, A⁺ is a metal such that the ionic liquid compound is of the formula (R¹R²P(═O)O⁻)ₙMⁿ⁺ wherein M is a metal and n corresponds to the charge of the metal. In one aspect, M is an alkali metal. In another aspect of the above, the IL does not contain any halide or is halide free.

In one aspect of the above compound, A⁺ is an ammonium cation of the formula 2:

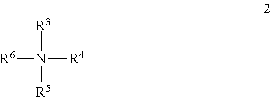

wherein R³, R⁴, R⁵ and R⁶ are each independently a bond or are selected from the group consisting of hydrogen, —CF₃, —C₂F₅, —C₃F₇, —C₄F₉, (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group, each of which may be unsubstituted or substituted with one or two —Cl, —Br, —I, —NO₂, CF₃O—, CH₃O—, —CO₂H, —NH₂, —OH, —SH, —NHCH₃, —N(CH₃)₂, —CN, —SMe, —SO₃H, —CF₃, —C₂F₅, —C₃F₇, —C₄F₉, —CH—CH, —CH₂CH═CH, -epoxide, —OC(O)—CH═CH, —NCO, —C(O)Cl, —C(O)Br, —C(O)-imidazolyl, —CO₂(C₁-C₃)alkyl, —P((C₁-C₅)alkyl)₂, —P(O)(OEt)₂, —OC(O)CH₂C(O)CH₃ and —CH═CR₁₀CO₂(C₁-C₃)alkyl, where R₁₀ is H or CH₃, or mixtures of the two substituents.

In another aspect of the above method, N⁺ together with R³, R⁴, R⁵ and R⁶ form a cation selected from the group consisting of ammonium, imidazolium, guanidinium, pyridinium, pyridazinium and 1,2,4-triazolium, each of which is unsubstituted or substituted by one or two substituents selected from the group consisting of —Cl, —Br, —I, —NO₂, CF₃O—, CH₃O—, —CO₂H, —NH₂, —OH, —SH, —NHCH₃, —N(CH₃)₂, —CN, —SMe, —SO₃H, —CF₃, —C₂F₅, —C₃F₇, —C₄F₉, —CH═CH, —CH₂CH═CH, -epoxide, —OC(O)—CH═CH, —NCO, —C(O)Cl, —C(O)Br, —C(O)-imidazolyl, —CO₂(C₁-C₃)alkyl, —P((C₁-C₅)alkyl)₂, —P(O)(OEt)₂, —OC(O)CH₂C(O)CH₃ and —CH═CR₁₀CO₂(C₁-C₃)alkyl, where R₁₀ is H or CH₃, or mixtures of the two substituents. As defined herein, the clause “N⁺ together with R³, R⁴, R⁵ and R⁶ form a cation selected from the group consisting of ammonium, imidazolium, guanidinium, pyridinium, pyridazinium and 1,2,4-triazolium” means that in certain embodiments where the cation is an acyclic or cyclic cation, one of R³, R⁴, R⁵ and R⁶ together with another R group (i.e., R³, R⁴, R⁵ and R⁶) on N⁺ may form a double bond.

In one aspect of the ammonium compound of the formula 2, the compound is selected from the group consisting of imidazolium, 1H-pyrazolium, 3H-pyrazolium, 4H-pyrazolium, 1-pyrazolinium, 2-pyrazolinium, 3-pyrazolinium, 2,3-dihydroimidazolinium, 4,5-dihydroimidazolinium, 2,5-dihydroimidazolinium, pyrrolidinium, 1,2,4-triazolium, 1,2,3-triazolium, pyridinium, pyridazinium, pyrimidinium, piperidinium, morpholinium, pyrazinium, thiazolium, oxazolium, indolium, quinolinium, isoquinolinium, quinoxalinium and indolinium.

In another aspect of the method, the compound of the formula 2 is selected from the group consisting of:

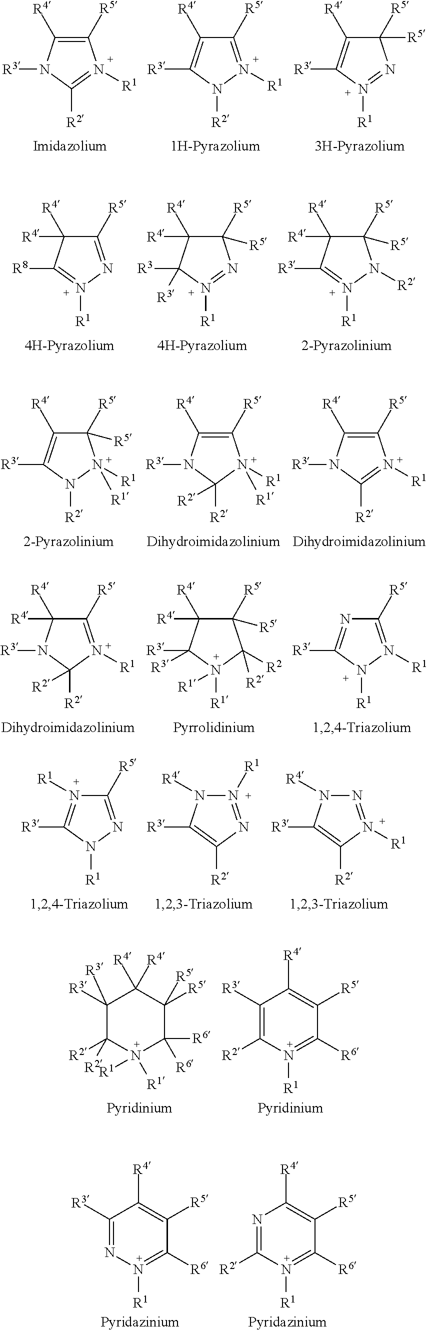

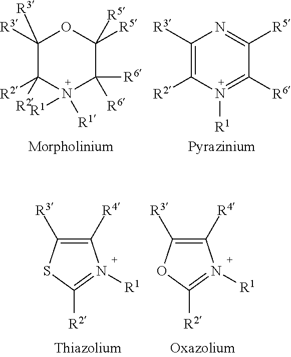

wherein:
each R¹, R^{1′}, R², R^{2′}, R³, R^{3′}, R⁴, R^{4′}, R⁵, R^{5′}, R⁶ and R^{6′} is independently selected from the group consisting of hydrogen, (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group, each of which may be unsubstituted or substituted with one or two halo, —NO₂, CF₃—, CF₃O—, CH₃O—, —CO₂H, —NH₂, —OH, —SH, —NHCH₃, —N(CH₃)₂, —CN, —SMe, —SO₃H, —CH═CH₂, —CH₂CH═CH₂, —P((C₁-C₅)alkyl)₂ and —P(O)(OEt)₂, or mixtures of the two substituents.

In one aspect of the above, each R¹, R^{1′}, R², R^{2′}, R³, R^{3′}, R⁴, R^{4′}, R⁵, R^{5′}, R⁶ and R^{6′} is independently selected from the group consisting of hydrogen, (C₁-C₁₀)alkyl and aryl(C₁-C₈)alkyl group, each of which may be unsubstituted or substituted with one or two halo, —NO₂, CF₃—, CF₃O—, CH₃O—, —CO₂H, —NH₂, —OH, —SH, —NHCH₃, —N(CH₃)₂, —CN, —SMe, —SO₃H, —CH═CH₂, —CH₂CH═CH₂, —P((C₁-C₅)alkyl)₂ and —P(O)(OEt)₂, or mixtures of the two substituents. In another aspect of the above, each R¹, R^{1′}, R², R^{2′}, R³, R^{3′}, R⁴, R^{4′}, R⁵, R^{5′}, R⁶ and R^{6′} is independently selected from the group consisting of hydrogen, —CH₃, —CF₃, —C₂F₅, —C₃F₇, —C₄F₉, unsubstituted (C₂-C₁₀)alkyl, —CH₂phenyl and (C₁-C₁₀)alkyl substituted with one —Cl, —Br, —I, —CF₃, —C₂F₅, —C₃F₇, —C₄F₉, —CH═CH, —CH₂CH═CH, —CH₂CHCH, -ethylene oxide, —OC(O)—CH═CH, —NCO, —C(O)Cl, —C(O)Br, —C(O)-imidazolyl and —CO₂(C₁-C₃)alkyl.

In another aspect of the method, the compound is of the formula 1a:

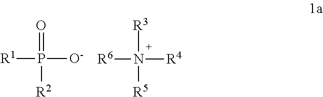

wherein:

R¹ and R² are each independently selected from the group consisting of (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group, each of which may be unsubstituted or substituted with one or two halo, —NO₂, CF₃—, CF₃O—, CH₃O—, —CO₂H, —NH₂, —OH, —SH, —NHCH₃, —N(CH₃)₂, —CN, —SMe, —SO₃H, —CH═CH₂, —CH₂CH═CH₂, —P((C₁-C₅)alkyl)₂ and —P(O)(OEt)₂, or mixtures of the substituents; and

wherein R³, R⁴, R⁵ and R⁶ are each independently a bond or are selected from the group consisting of hydrogen, —CF₃, —C₂F₅, —C₃F₇, —C₄F₉, (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group, each of which may be unsubstituted or substituted with one or two —Cl, —Br, —I, —NO₂, CF₃O—, CH₃O—, —CO₂H, —NH₂, —OH, —SH, —NHCH₃, —N(CH₃)₂, —CN, —SMe, —SO₃H, —CF₃, —C₂F₅, —C₃F₇, —C₄F₉, —CH═CH, —CH₂CH═CH, -epoxide, —OC(O)—CH═CH, —NCO, —C(O)Cl, —C(O)Br, —C(O)-imidazolyl, —CO₂(C₁-C₃)alkyl, —P((C₁—O₅)alkyl)₂, —P(O)(OEt)₂, —OC(O)CH₂C(O)CH₃ and —CH═CR₁₀CO₂(C₁-C₃)alkyl, where R₁₀ is H or CH₃, or mixtures of the two substituents; or wherein N⁺ together with R³, R⁴, R⁵ and R⁶ form a cation selected from the group consisting of ammonium, imidazolium, guanidinium, pyridinium, pyridazinium and 1,2,4-triazolium, each of which is unsubstituted or substituted by one or two substituents selected from the group consisting of —Cl, —Br, —I, —NO₂, CF₃O—, CH₃O—, —CO₂H, —NH₂, —OH, —SH, —NHCH₃, —N(CH₃)₂, —CN, —SMe, —SO₃H, —CF₃, —C₂F₅, —C₃F₇, —C₄F₉, —CH═CH, —CH₂CH═CH, -epoxide, —OC(O)—CH═CH, —NCO, —C(O)Cl, —C(O)Br, —C(O)-imidazolyl, —CO₂(C₁-C₃)alkyl, —P((C₁-C₅)alkyl)₂, —P(O)(OEt)₂, —OC(O)CH₂C(O)CH₃ and —CH═CR₁₀CO₂(C₁-C₃)alkyl, where R₁₀ is H or CH₃, or mixtures of the two substituents.

In yet another aspect of the method, the compound is of the formula 1a, wherein at least one of R₁, R₂, R₃, R₄, R₅ or R₆ is selected from the group consisting of —CF₃, —C₂F₅, —C₃F₇, —C₄F₉, unsubstituted (C₁-C₁₀)alkyl, and (C₁-C₁₀)alkyl substituted with one —Cl, —Br, —I, —CF₃, —C₂F₅, —C₃F₇, —C₄F₉, —CH═CH, —CH₂CH═CH, —CH₂CHCH, -ethylene oxide, —OC(O)—CH═CH, —NCO, —C(O)Cl, —C(O)Br, —C(O)-imidazolyl, —CO₂(C₁-C₃)alkyl, —OC(O)CH₂C(O)CH₃ and —CH═CR₁₀CO₂(C₁-C₃)alkyl, where R₁₀ is H or CH₃. In yet another aspect of the method, the compound is of the formula:

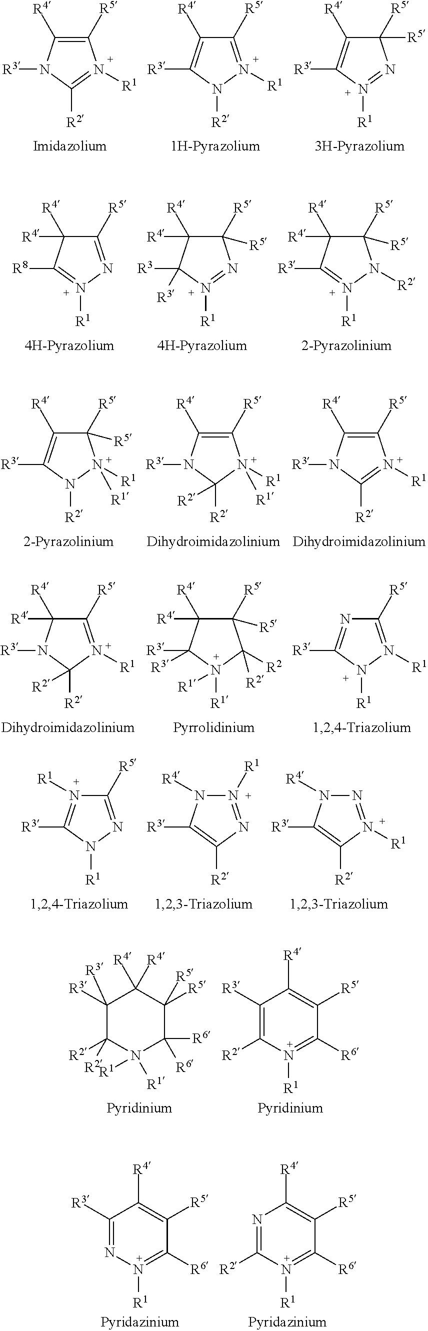

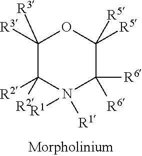

In one variation, the method further comprises contacting or formulating the ionic liquid with a second different ionic liquid. As disclosed herein, the second, different ionic liquid may be one of the ionic liquids recited in the claims. In another aspect of the above, the method further comprises contacting or formulating the material with an ionic liquid in combination with an agent selected from the group consisting of a mineral flame retardant, a halogenated flame retardant, a phosphorus based flame retardant, a nitrogen based flame retardant, a silicon based flame retardants and nanometric particles, and combinations thereof. In one aspect, the added agent is selected from the group consisting of organoclay, zinc borate (ZnB), borophosphate (BPO₄), or combination thereof.

In another aspect of the method, the material is selected from the group consisting of textile, resin, plastic, rubber, leather, paper and wood products. In one aspect of the above, the material may be rigid or flexible foam materials, composite materials, particle boards and Oriented Strand Board (OSB).

In another embodiment, there is provided a flame retardant or flame resistant material comprising an effective amount of a flame retardant composition comprising an ionic liquid compound of the formula 1:

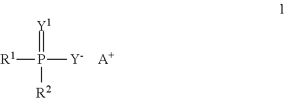

wherein:

Y and Y¹ are each independently selected from O or S;
R¹ and R² are each independently selected from the group consisting of hydrogen, (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group, each of which may be unsubstituted or substituted with one or two halo, —NO₂, CF₃—, CF₃O—, CH₃O—, —CO₂H, —NH₂, —OH, —SH, —NHCH₃, —N(CH₃)₂, —CN, —SMe, —SO₃H, —CH═CH₂, —CH₂CH═CH₂, —P((C₁-C₅)alkyl)₂ and —P(O)(OEt)₂, or mixtures of the substituents;

A⁺ is a cation selected from the group consisting of an ammonium, imidazolium, guanidinium, pyridinium, pyridazinium, 1,2,4-triazolium, triazine, sulfonium, phosphazenium and phosphonium cation; and optionally, wherein the A⁺ is a cation as defined above that is covalently bonded to a polymer. In one variation, Y and Y¹ are both O.

In one aspect of the above, the material is selected from the group consisting of textile, fabric, resin, plastic, rubber, leather, paper and wood products, and surface coating formulations. In another aspect, the fabric comprises natural fibers or synthetic fibers selected from the group consisting of nylon, polyacrylates, polyesters and polyamides and combinations thereof. In one aspect of the above flame retardant or resistant fabric, the flame retardant composition further comprises of an additive selected from the group consisting of softening agent, stain repellant agents and combinations thereof. In one embodiment, there is provided a method of preparing a flame retardant or resistant fabric of the above, wherein the fabric comprises cellulosic fibers in about 10% to 99% by weight, synthetic fibers in about 1% to about 30% by weight, and the ionic liquid composition comprises of less than 5% by weight of the fabric, the method comprising:

1) contacting the fabric with a composition comprising one or more ionic liquid flame retardant composition comprising the formula 1 for a sufficient amount of time to allow the ionic liquid to penetrate the fabric;
2) curing the fabric at a temperature of about 100° C. to 300° C. for a sufficient amount of time to impregnate the ionic liquid onto the fabric.

In one aspect of the above, the material is a polymer selected from the group consisting of a thermoplastic, phenolics, polycarbonates, polyurethanes, polyesters, polyethylene, polypropylene, polyacrylic acid, butadiene/acrylonitrile-acrylonitrile/styrene copolymers, ethylene-vinyl acetate copolymers, polyamides, acrylic resins and epoxy resins. In another aspect, there is provided the flame retardant or resistant material as described herein, wherein the material is a coating composition, a film, a composite material, an adhesive and a sealing composition.

In one embodiment, ionic liquids of the present application are further modified by the incorporation with ethereal side chains to provide biodegradable and nontoxic ionic liquids. See, for example, Greener Solvents; Room Temperature Ionic Liquids from Biorenewable Sources, Scott Handy, Chem. Eur. J. 2003, 9, 2938-2944.

### Flame Retardant and Flame Resistant Applications:

In another embodiment, there is provided a method for fighting or suppressing fire or forest fire, the method comprises:
a) preparing a flame retardant formulation comprising an ionic liquid compound of the formula 1:

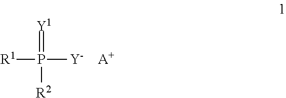

wherein:

Y and Y¹ are each independently selected from O or S;

R¹ and R² are each independently selected from the group consisting of hydrogen, (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group, each of which may be unsubstituted or substituted with one or two halo, —NO₂, CF₃—, CF₃O—, CH₃O—, —CO₂H, —NH₂, —OH, —SH, —NHCH₃, —N(CH₃)₂, —CN, —SMe, —SO₃H, —CH═CH₂, —CH₂CH═CH₂, —P((C₁-C₅)alkyl)₂ and —P(O)(OEt)₂, or mixtures of the substituents;

A⁺ is a cation selected from the group consisting of an ammonium, imidazolium, guanidinium, pyridinium, pyridazinium, 1,2,4-triazolium, triazine, sulfonium, phosphazenium and phosphonium cation;

b) optionally mixing the composition with a high viscosity gum thickener or other flame retardants; c) optionally further mixing the ionic liquid compound with water; and d) applying the formulation to the fire. In one variation, Y and Y¹ are both O.

In one aspect of the flame retardant material, the material is selected from the group consisting of textile, fabric, resin, plastic, rubber, leather, paper and wood products. In another aspect of the above fabric, the fabric comprises synthetic fibers selected from the group consisting of nylon, polyacrylates, polyesters and polyamides and combinations thereof. In one variation of the above textile or fabric may be a natural or synthetic textile or fabric. In another aspect of the above, the flame retardant composition further comprises of an additive selected from the group consisting of softening agent, stain repellant agents and combinations thereof. In one aspect, the flame resistant fabric provides a fabric characterized by an after flame time, as defined by ASTM D 6413 12 seconds ignition test, of less than 2 seconds. Test Method D 6413 has been adopted from Federal Test Standard No. 191A. This test method determines the response of textiles to a standard ignition source, deriving measurement values for after flame time, afterglow time, and char length. The vertical flame resistance, as determined by this test method, relates to a specified flame exposure and application time.

In another aspect, there is provided a method of preparing a flame retardant or resistant fabric as provided above, wherein the fabric comprises cellulosic fibers in about 10% to 99% by weight, synthetic fibers in about 1% to about 30% by weight, and the ionic liquid composition comprises of less than 5% by weight of the fabric, the method comprising:

1) contacting the fabric with a composition comprising one or more ionic liquid flame retardant composition comprising the formulae of the present application for a sufficient amount of time to allow the ionic liquid to penetrate the fabric;

2) curing the fabric at a temperature of about 100° C. to 300° C. for a sufficient amount of time to impregnate the ionic liquid onto the fabric.

In another variation of the above flame retardant or resistant material, the material is a polymer selected from the group consisting of a thermoplastic, phenolics, polycarbonates, polyurethanes, polyesters, polyethylene, polypropylene, polyacrylic acid, butadiene/acrylonitrile-acrylonitrile/styrene copolymers, ethylene-vinyl acetate copolymers, polyamides, acrylic resins and epoxy resins. In another variation of the above material, the material is a coating composition, a film, a composite material, an adhesive and a sealing composition. In one variation there is provided a method of imparting a flame retarding property to a material comprising treating said material with an effective flame retarding amount of the composition of the formulas above in combination with a metal hydroxide, hydroxyl carbonate, borates and the like.

In another variation there is provided a method of imparting a flame retarding property to a material comprising treating said material with an effective flame retarding amount of the composition of the formulas above combined with a organic flame retardant. In another variation, there is provided a method of imparting a flame retarding property to a material comprising treating said material with an effective flame retarding amount of the composition of the formulas above combined with a halogenated flame retardant. In another variation there is provided a method of imparting a flame retarding property to a material comprising treating said material with an effective flame retarding amount of the composition of the formulas above combined with halogenated flame retardant additives, halogenated monomers and copolymers which are reactive flame retardants, and the like.

In yet another variation there is provided a method of imparting a flame retarding property to a material comprising treating said material with an effective flame retarding amount of the composition of the formulas above combined with a phosphorus based flame retardant. In another variation, there is provided a flame retardant composition comprising an ionic liquid combined with red phosphorus, inorganic phosphorus, organic phosphorus based compounds, intumescent flame retardant systems and the like.

In a particular variation, there is provided a method of imparting a flame retarding property to a material comprising treating said material with an effective flame retarding amount of the composition of the formulas above combined with a nitrogen based flame retardant. In yet another variation, there is provided a method of imparting a flame retarding property to a material comprising treating said material with an effective flame retarding amount of the composition of the formulas above combined with silicon based flame retardants. In another variation, there is provided a method of imparting a flame retarding property to a material comprising treating said material with an effective flame retarding amount of the composition of the formulas above combined with silicones, silica and the like.

In another variation there is provided a method of imparting a flame retarding property to a material comprising treating said material with an effective flame retarding amount of the composition of the formulas above combined with nanometric particles. In a particular variation, there is provided a method of imparting a flame retarding property to a material comprising treating said material with an effective flame retarding amount of the composition of the formulas above combined with a nanoclay, carbon nanotubes, nanoscale particulate additives.

In another variation there is provided a method of imparting a flame retarding property to a material comprising treating said material with an effective flame retarding amount of the composition of the formulas above also functioning as a dispersant. In another variation there is provided a method of imparting a flame retarding property to a material comprising treating said material with an effective flame retarding amount of the composition of the formulas above also functioning as a plasticizer.

In a variation there is provided a method of imparting a flame retarding property to a material comprising treating said material with an effective flame retarding amount of the composition of the formulas above also functioning as an antibacterial. In another variation there is provided a method of imparting a flame retarding property to a material comprising treating said material with an effective flame retarding amount of the composition of the formulas above also functioning as a lubricant. In yet another variation there is provided a method of imparting a flame retarding property to a material comprising treating said material with an effective flame retarding amount of the composition of the formulae above that also function as an anti-corrosion agent.

In one aspect, the ionic liquid flame retardant compositions of the invention maybe derived from biofeedstock such as carbohydrates, amino acids, fatty acids, nucleotides and other organic and inorganic chemicals derived from biofeedstock.

### Reducing Melt Viscosity in Polymers Processing:

In one embodiment, there is provided a method for reducing the melt viscosity of a polymer, or a method for the crystallization enhancement for semicrystalline polymers, during the processing of the polymer comprising adding a composition comprising an ionic liquid compound with the polymer before processing the polymer, wherein:

a) the ionic liquid compound is of the formula 1:

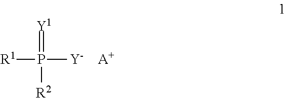

wherein:

Y and Y¹ are each independently selected from O or S;

R¹ and R² are each independently selected from the group consisting of hydrogen, (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group, each of which may be unsubstituted or substituted with one or two halo, —NO₂, CF₃—, CF₃O—, CH₃O—, —CO₂H, —NH₂, —OH, —SH, —NHCH₃, —N(CH₃)₂, —CN, —SMe, —SO₃H, —CH═CH₂, —CH₂CH═CH₂, —P((C₁-C₅)alkyl)₂ and —P(O)(OEt)₂, or mixtures of the substituents;

A⁺ is a cation selected from the group consisting of an ammonium, imidazolium, guanidinium, pyridinium, pyridazinium, 1,2,4-triazolium, triazine, sulfonium, phosphazenium and phosphonium cation; and

optionally, wherein the A⁺ is a cation as defined above that is covalently bonded to a polymer; or

b) the ionic liquid compound is of the formula 1, wherein:

A⁺ is an ammonium cation of the formula 2:

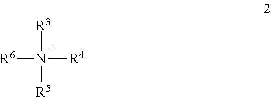

wherein R³, R⁴, R⁵ and R⁶ are each independently a bond or are selected from the group consisting of hydrogen, —CF₃, —C₂F₅, —C₃F₇, —C₄F₉, (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group, each of which may be unsubstituted or substituted with one or two —Cl, —Br, —I, —NO₂, CF₃O—, CH₃O—, —CO₂H, —NH₂, —OH, —SH, —NHCH₃, —N(CH₃)₂, —CN, —SMe, —SO₃H, —CF₃, —C₂F₅, —C₃F₇, —C₄F₉, —CH═CH, —CH₂CH═CH, -epoxide, —OC(O)—CH═CH, —NCO, —C(O)Cl, —C(O)Br, —C(O)-imidazolyl, —CO₂(C₁-C₃)alkyl, —P((C₁—O₅)alkyl)₂, —P(O)(OEt)₂, —OC(O)CH₂C(O)CH₃ and —CH═CR₁₀CO₂(C₁-C₃)alkyl, where R₁₀ is H or CH₃, or mixtures of the two substituents; or

c) the ionic liquid compound is of the formula 2, wherein:

N⁺ together with R³, R⁴, R⁵ and R⁶ form a cation selected from the group consisting of ammonium, imidazolium, guanidinium, pyridinium, pyridazinium and 1,2,4-triazolium, each of which is unsubstituted or substituted by one or two substituents selected from the group consisting of —Cl, —Br, —I, —NO₂, CF₃O—, CH₃O—, —CO₂H, —NH₂, —OH, —SH, —NHCH₃, —N(CH₃)₂, —CN, —SMe, —SO₃H, —CF₃, —C₂F₅, —C₃F₇, —C₄F₉, —CH═CH, —CH₂CH═CH, -epoxide, —OC(O)—CH═CH, —NCO, —C(O)Cl, —C(O)Br, —C(O)-imidazolyl, —CO₂(C₁-C₃)alkyl, —P((C₁-C₅)alkyl)₂, —P(O)(OEt)₂, —OC(O)CH₂C(O)CH₃ and —CH═CR₁₀CO₂(C₁-C₃)alkyl, where R₁₀ is H or CH₃, or mixtures of the two substituents; or

d) the ionic liquid compound of the formula 2 is selected from the group consisting of:

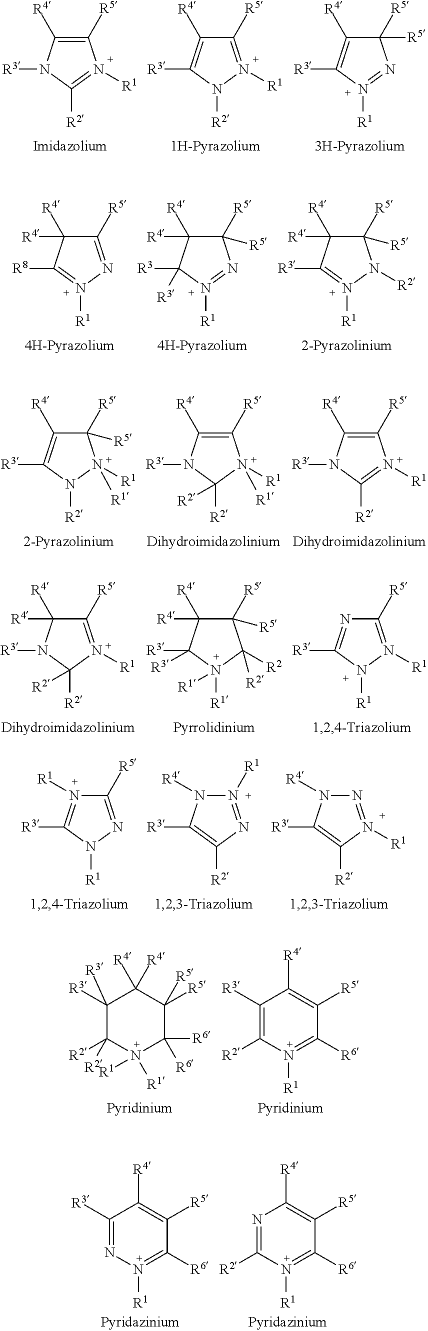

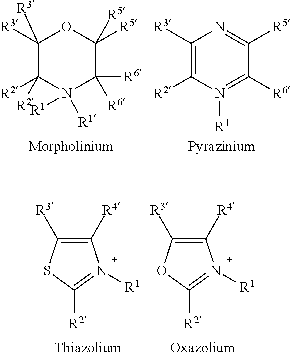

wherein:

each R¹, R^{1′}, R², R^{2′}, R³, R^{3′}, R⁴, R^{4′}, R⁵, R^{5′}, R⁶ and R^{6′} is independently selected from the group consisting of hydrogen, (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group, each of which may be unsubstituted or substituted with one or two halo, —NO₂, CF₃—, CF₃O—, CH₃O—, —CO₂H, —NH₂, —OH, —SH, —NHCH₃, —N(CH₃)₂, —CN, —SMe, —SO₃H, —CH═CH₂, —CH₂CH═CH₂, —P((C₁-C₅)alkyl)₂ and —P(O)(OEt)₂, or mixtures of the two substituents; or

e) wherein each R¹, R^{1′}, R², R^{2′}, R³, R^{3′}, R⁴, R^{4′}, R⁵, R^{5′}, R⁶ and R^{6′} is independently selected from the group consisting of hydrogen, —CH₃, —CF₃, —C₂F₅, —C₃F₇, —C₄F₉, unsubstituted (C₂-C₁₀)alkyl, —CH₂phenyl and (C₁-C₁₀)alkyl substituted with one —Cl, —Br, —I, —CF₃, —C₂F₅, —C₃F₇, —C₄F₉, —CH═CH, —CH₂CH═CH, —CH₂CHCH, -ethylene oxide, —OC(O)—CH═CH, —NCO, —C(O)Cl, —C(O)Br, —C(O)-imidazolyl and —CO₂(C₁-C₃)alkyl; or

f) wherein the compound is of the formula 1a:

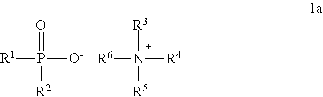

wherein:

R¹ and R² are each independently selected from the group consisting of (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group, each of which may be unsubstituted or substituted with one or two halo, —NO₂, CF₃—, CF₃O—, CH₃O—, —CO₂H, —NH₂, —OH, —SH, —NHCH₃, —N(CH₃)₂, —CN, —SMe, —SO₃H, —CH═CH₂, —CH₂CH═CH₂, —P((C₁—O₅)alkyl)₂ and —P(O)(OEt)₂, or mixtures of the substituents; and

wherein R³, R⁴, R⁵ and R⁶ are each independently a bond or are selected from the group consisting of hydrogen, —CF₃, —C₂F₅, —C₃F₇, —C₄F₉, (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group, each of which may be unsubstituted or substituted with one or two —Cl, —Br, —I, —NO₂, CF₃O—, CH₃O—, —CO₂H, —NH₂, —OH, —SH, —NHCH₃, —N(CH₃)₂, —CN, —SMe, —SO₃H, —CF₃, —C₂F₅, —C₃F₇, —C₄F₉, —CH═CH, —CH₂CH═CH, -epoxide, —OC(O)—CH═CH, —NCO, —C(O)Cl, —C(O)Br, —C(O)-imidazolyl, —CO₂(C₁-C₃)alkyl, —P((C₁-C₅)alkyl)₂, —P(O)(OEt)₂, —OC(O)CH₂C(O)CH₃ and —CH═CR₁₀CO₂(C₁-C₃)alkyl, where R₁₀ is H or CH₃, or mixtures of the two substituents; or

wherein N⁺ together with R³, R⁴, R⁵ and R⁶ form a cation selected from the group consisting of ammonium, imidazolium, guanidinium, pyridinium, pyridazinium and 1,2,4-triazolium, each of which is unsubstituted or substituted by one or two substituents selected from the group consisting of —Cl, —Br, —I, —NO₂, CF₃O—, CH₃O—, —CO₂H, —NH₂, —OH, —SH, —NHCH₃, —N(CH₃)₂, —CN, —SMe, —SO₃H, —CF₃, —C₂F₅, —C₃F₇, —C₄F₉, —CH═CH, —CH₂CH═CH, -epoxide, —OC(O)—CH═CH, —NCO, —C(O)Cl, —C(O)Br, —C(O)-imidazolyl, —CO₂(C₁-C₃)alkyl, —P((C₁—O₅)alkyl)₂, —P(O)(OEt)₂, —OC(O)CH₂C(O)CH₃ and —CH═CR₁₀CO₂(C₁-C₃)alkyl, where R₁₀ is H or CH₃, or mixtures of the two substituents; or

g) wherein the compound is of the formula 1a:

wherein at least one of R₁, R₂, R₃, R₄, R₅ or R₆ is selected from the group consisting of —CF₃, —C₂F₅, —C₃F₇, —C₄F₉, unsubstituted (C₁-C₁₀)alkyl, and (C₁-C₁₀)alkyl substituted with one —Cl, —Br, —I, —CF₃, —C₂F₅, —C₃F₇, —C₄F₉, —CH═CH, —CH₂CH═CH, —CH₂CHCH, -ethylene oxide, —OC(O)—CH═CH, —NCO, —C(O)Cl, —C(O)Br, —C(O)-imidazolyl, —CO₂(C₁-C₃)alkyl, —OC(O)CH₂C(O)CH₃ and —CH═CR₁₀CO₂(C₁-C₃)alkyl, where R₁₀ is H or CH₃; or

h) wherein the compound is of the formula:

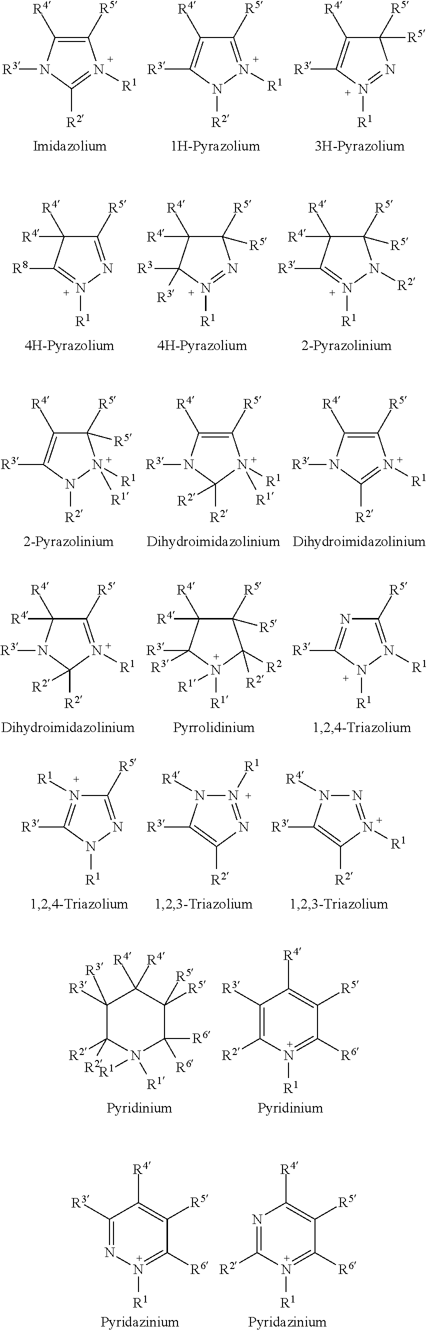

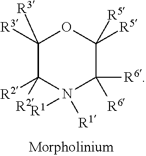

In one aspect of the above, the polymer is selected from the group consisting of polypropylene, polystyrene, polyethyleneterephthalate (PET), polycarbonate, thermoplastic, phenolics, polycarbonates, polyurethanes, polyesters, polyethylene, polypropylene, polyacrylic acid, butadiene/acrylonitrile-acrylonitrile/styrene copolymers, ethylene-vinyl acetate copolymers, polyamides, acrylic resins and epoxy resins. In one variation, Y and Y¹ are both O. In another aspect, the ionic liquid compound comprises 0.01% wt/wt, 0.02% wt/wt, 0.03% wt/wt, 0.05% wt/wt, 0.1% wt/wt, 0.5% wt/wt, 1.0% wt/wt, 1.5% wt/wt, 2.0% wt/wt, 2.5% wt/wt, 3% wt/wt, 10% wt/wt, 20% wt/wt, 40% wt/wt, 50% wt/wt or more of the polymer. In another aspect, the processing of the polymer is selected from the group consisting of injection molding, extrusion, compression molding and thermomolding. In one aspect, the process allows the processing of polymers, such as plastics, at significantly lower temperatures (lower by at least about 5° C., 10° C., 20° C., 30° C., 50° C., 75° C. or about 100° C. or more), lower pressures (lower by at least 5%, 10%, 15%, 20%, 30%, 50% or more) and lower viscosity (by at least 1 fold, 2 folds, 3 folds, 4 folds, 5 folds, 6 folds, 10 folds or more), or a combination thereof, when compared to the processing of the same polymers without the ILs. In one aspect, the processing of the polymers with the ILs provides significant increase in throughputs and shorter cycle times. In one aspect of the above, the process reduces the number of defects such as weld lines, sink marks and warpage of polymer materials, such as molded polymer materials. In addition, the process provides materials with reduced defects and with increased strength. In another aspect, the method provides a material with increased tensile strength, increased stiffness, increased hardness, increased impact strength, increased weld line strength, increased dimensional stability and decrease in the number of voids and sink marks. In another aspect, the process provides the material with significantly improved mechanical properties, such as tensile strength and modulus of elasticity.

Compounds of the present application, or derivatives thereof, may possess a reactive function such as an alkene, acrylate, isocyanate, acid chloride, epoxide or other functional group that enables bonding to other compounds and polymers and imparts flame retarding properties to said compounds and polymers.

In addition to the exemplary embodiments, aspects and variations described above, further embodiments, aspects and variations will become apparent by reference to the drawings and figures and by examination of the following descriptions.

### DETAILED DESCRIPTION OF THE INVENTION

### Definitions

Unless specifically noted otherwise herein, the definitions of the terms used are standard definitions used in the chemical arts. Exemplary embodiments, aspects and variations are illustratived in the figures and drawings, and it is intended that the embodiments, aspects and variations, and the figures and drawings disclosed herein are to be considered illustrative and not limiting.

In one variation, the group that is an alkyl, aryl, heterocyclyl, (C₁-C₈)cycloalkyl, hetrocyclyl(C₁-C₈)alkyl, aryl(C₁-C₈)alkyl, heteroaryl or heteroaryl(C₁-C₈)alkyl group may be substituted or unsubstituted.

An “alkyl” group is a straight, branched, saturated or unsaturated, aliphatic group having a chain of carbon atoms, optionally with oxygen, nitrogen or sulfur atoms inserted between the carbon atoms in the chain or as indicated. A (C₁-C₂₀)alkyl, for example, includes alkyl groups that have a chain of between 1 and 20 carbon atoms, and include, for example, the groups methyl, ethyl, propyl, isopropyl, vinyl, allyl, 1-propenyl, isopropenyl, ethynyl, 1-propynyl, 2-propynyl, 1,3-butadienyl, penta-1,3-dienyl, penta-1,4-dienyl, hexa-1,3-dienyl, hexa-1,3,5-trienyl, and the like. An alkyl group may also be represented, for example, as a —(CR¹R²)ₘ— group where R¹ and R² are independently hydrogen or are independently absent, and for example, m is 1 to 8, and such representation is also intended to cover both saturated and unsaturated alkyl groups.

An alkyl as noted with another group such as an aryl group, represented as “arylalkyl” for example, is intended to be a straight, branched, saturated or unsaturated aliphatic divalent group with the number of atoms indicated in the alkyl group (as in (C₁-C₂₀)alkyl, for example) and/or aryl group (as in (C₅-C₁₄)aryl, for example) or when no atoms are indicated means a bond between the aryl and the alkyl group. Nonexclusive examples of such group include benzyl, phenethyl and the like.

An “alkylene” group is a straight, branched, saturated or unsaturated aliphatic divalent group with the number of atoms indicated in the alkyl group; for example, a —(C₁-C₃)alkylene- or —(C₁-C₃)alkylenyl-.

A “cyclyl” such as a monocyclyl or polycyclyl group includes monocyclic, or linearly fused, angularly fused or bridged polycycloalkyl, or combinations thereof. Such cyclyl group is intended to include the heterocyclyl analogs. A cyclyl group may be saturated, partially saturated or aromatic.

The term “cellulose” or “cellulose fiber” generally refers to a fiber composed of, or derived from, cellulose, a main component of the cell walls of plants. Examples of cellulose or cellulosic fibers include cotton, rayon, linen, jute, hemp and cellulose acetate.

The term “flame resistant” is used to describe a material that burns slowly or that is self-extinguishing after removal of an external source of ignition. For example, as the term relates to fabric or textiles, a fabric or yarn may be flame resistant because of the innate properties of the fiber, the fabric construction, or the presence of flame retardant compounds or formulations applied to the fabric.

The term “flame retardant” or “flame retardant compound” as it relates to textiles or fabric, refers to a compound that may be applied as a topical treatment to a fiber, fabric, or other textile item during processing to reduce its flammability. In some aspects, flame retardant chemicals are applied to the already constructed fabric substrate to produce a flame resistant fabric.

“Halogen” or “halo” means fluorine, chlorine, bromine or iodine.

A “heterocyclyl” or “heterocycle” is a mono-cycloalkyl or bi-cycloalkyl wherein one or more of the atoms forming the ring or rings is a heteroatom that is a N, O, or S. Non-exclusive examples of heterocyclyl include piperidyl, 4-morpholyl, 4-piperazinyl, pyrrolidinyl, 1,4-diazaperhydroepinyl, 1,3-dioxanyl, and the like. In one aspect, the heterocyclyl may also include carbohydrate-based compounds, such as glucose. Accordingly, the ILs of the present application includes sugar-derived ILs, including glucose-derived ILs. Such glucose derived ILs include 1,5-anhydro-2,3,4-tri-O-methyl-D-glucitol-6-O-triethylammonium trifluoromethanesulfonate, 1,5-anhydro-2,3,4-tri-O-methyl-D-glucitol-6-0-diethylsulfonium trifluoromethanesulfonate and 1,5-anhydro-2,3,4-tri-O-methyl-D-glucitol-6-O-tetrahydrothiophenyl trifluoromethanesulfonate.

Salts include acid addition salts formed with inorganic acids such as hydrochloric acid, hydrobromic acid, sulfuric acid, phosphoric acid, and the like; or with organic acids such as acetic acid, propionic acid, hexanoic acid, malonic acid, succinic acid, malic acid, citric acid, gluconic acid, salicylic acid and the like.

“Substituted or unsubstituted” or “optionally substituted” means that a group such as, for example, alkyl (such as C₁-C₂₀alkyl), aryl, heterocyclyl, (C₁-C₈)cycloalkyl, hetrocyclyl(C₁-C₈)alkyl, aryl(C₁-C₈)alkyl, heteroaryl, heteroaryl(C₁-C₈)alkyl, and the like, unless specifically noted otherwise, may be unsubstituted or, may substituted by 1, 2 or 3 Substituents selected from the group such as halo, nitro, trifluoromethyl, trifluoromethoxy, methoxy, carboxy, —NH₂, —OH, —SH, —NHCH₃, —N(CH₃)₂, —SMe, cyano and the like.

In one embodiment, the ILs of the present application may be racemic compounds or may be chiral substantially enantiomeric or diastereomeric pure or mixtures thereof.

The present disclosure may be understood by reference to the following detailed description taken in conjunction with the drawings described below.

To replace brominated flame retardants and other chemical compounds that may have toxic bioaccumulative effects; a different class of materials, namely ionic liquids (“IL”), may be used for the purpose of flame retarding.

An ionic liquid is a salt in which the ions are poorly coordinated as is well known in the art. At least one ion in the salt has a delocalized charge and one component is organic, which prevents the formation of a stable crystal lattice.

Ionic liquids have capabilities to form a wide range of intermolecular interactions that include strong and weak ionic, hydrogen boding, van der Waals, dispersive, π-π interactions. Ionic liquids exhibit compatibility with a wide variety of materials including salts, fats, proteins, amino acids, surfactants, oils, inks and plastics, and even DNA. Ionic liquids have been intensively studied for many applications, such as solvents, catalysts, separation, extraction, biomass processing, etc. ILs have been used as plasticizers, dispersants, and lubricants. When used as plasticizers, they show excellent resistance to migration and leaching which mitigates one of the most significant issues with current flame retardant compounds.

Phosphinate ionic liquid flame retardants may be suitably configured by selection of cations and anions chosen from, but not limited to, those disclosed herein.

Ionic liquids are compounds which may contain halogen, nitrogen, phosphorus, sulfur or some combination of these elements. Ionic liquid compounds may be designed with halogen, nitrogen, sulfur, phosphorus or some combinations of these elements, and so the compounds may be used as flame retardants, either though physical action or chemical action to inhibit combustion processes as discussed above.

Due to the large number of possible combinations of ion pairs, the ability to select the physical and chemical properties of possible ionic liquid flame retardants is essentially unlimited. Functionalization of a ligand or “head”, such as by changing the length of a ligand R group, adding a ligand to different positions of a head, and/or adding a halogen to a ligand or head further increases the number of possible ionic liquid flame retardants. The head may be defined as the positively charged core atom or ring of the cation species of the ionic liquid.

In one embodiment, ionic liquids are modified to design biodegradable and nontoxic ionic liquids via incorporation of ethereal side chains. See for example, Greener Solvents; Room Temperature Ionic Liquids from Biorenewable Sources, Scott Handy, Chem. Eur. J. 2003, 9, 2938-2944.

In another embodiment incorporation of reactive groups into ligands, produces ionic liquids which may be chemically bound with a substrate to impart flame retarding properties to substrates. Other reactive groups may include, but are not limited to hydroxyl and/or carboxyl groups.

In another embodiment, ionic liquids may be formulated with other ionic liquids, or traditional flame retardants or additives. These traditional flame retardants can be mineral flame retardants, halogen containing flame retardants, phosphorous based flame retardants, nitrogen based flame retardants, silicon based flame retardants, nanometric particles, etc. Mineral flame retardants can be metal hydroxides, hydroxycarbonates, borates, etc.; halogen containing flame retardants can be halogen flame retardant additives, reactive halogenated flame retardant monomers or polymers; phosphorous based flame retardants can be red phosphorous, inorganic phosphate, organic phosphorous based compounds, etc.; silicon based flame retardants can be silicon, silica compounds, etc.; nanometric particles can be nanoclay, carbon nanotube, nanoscale particulate additives, etc.

Ionic liquids may also be used as multifunctional additives. For example, an ionic liquid may be used as a lubricant and flame retardant, a plasticizer and flame retardant, a dispersant and flame retardant, and an antibacterial agent and flame retardant.

The proposed flame retardants can be used in many fields including plastics, textiles, paper, leather, wood, etc. In addition, the flame retardants of the present application can also be used as flame retardants for fighting forest fires.

### DESCRIPTION OF THE FIGURE

FIG. 1 is a depiction of an apparatus for conducting a flammability test.

### EXAMPLES

The materials and reagents used are either available from commercial suppliers or are prepared by methods well known to a person of ordinary skill in the art, following procedures described in such references as Fieser and Fieser's Reagents for Organic Synthesis, vols. 1-17, John Wiley and Sons, New York, N.Y., 1991; Rodd's Chemistry of Carbon Compounds, vols. 1-5 and supps., Elsevier Science Publishers, 1989; Organic Reactions, vols. 1-40, John Wiley and Sons, New York, N.Y., 1991; March J.: Advanced Organic Chemistry, 4th ed., John Wiley and Sons, New York, N.Y.; and Larock: Comprehensive Organic Transformations, VCH Publishers, New York, 1989.

Treatment of Polymers and Resins with IL Flame Retardants:

In one example of polymers containing ILs, the polymer may comprise of about 80 to 99.9 weight percent of the composition that is blended with the IL, and optionally, also with an additive, as provided herein. In one variation, the polymer is a polyolefin. In one variation of the polymer composition, the polyolefin is selected from polypropylene and polyethylene, such as isotactic, atactic and syndiotactic polypropylene, HDPE, LDPE and LLDPE, random and heterophasic copolymers of propylene, ethylene, butene, hexene and octane. In another variation, the polymer is selected from at least one of polyesters, epoxy resins, ABS combinations, halogenated polymers, polyethylene, polystyrene, silicones, silicone rubbers, ethyl vinyl acetate, and their copolymers.

In one aspect of the present application, the polymer is a resin. Such resin may include thermoplastic resin, thermoset resin, thermoplastic resin blend or thermoset resin blend. In one variation, the resin may be selected from polycarbonates, polyamides, polyesters, blends of polycarbonates with other polymers, polyphenylene ether, polyphenyleneoxide, blends of polyphenylene ether with styrenics, blends of polyphenyleneoxide with styrenic materials, polyaramids, polyimides, styrenic materials, polyacrylates, styrene-acrylonitrile resins, halogenated plastics, polyketones, polymethylmethacrylate (PMMA), thermoplastic elastomers, cellulosics, rayon or polylactic acid. In another variation, the polymer employed may be polycarbonates, polycaprolactam, polylauryllactam, polyhexamethyleneadipamide, polyhexamethylenedodecanamide, blends of Nylons with other polymers, polybutylene terephthalate, polyethylene terephthalate, polyethylene naphthalate, polycarbonate-acrylonitrile-butadiene-styrene blends, polycarbonate-polybutylene terephthalate blends, polyphenylene ether, polyphenyleneoxide, polyphenylene sulfide, polyether sulphone, polyethylene sulfide, acrylonitrile-butadiene-styrene, polystyrene, styrene-acrylonitrile resins, polyvinyl chloride, fluoroplastics, polymethylmethacrylate, thermoplastic urethanes, thermoplastic vulcanizates, or styrene ethylene butylene styrene copolymer.

The resins of may be uncured resins that have no curing agent, semi-cured resins or cured resins. In a particular variation, the amount of the IL that may be incorporated into the resins of the present application may be about 0.01 to about 50% or higher by weight, about 0.01 to about 40% by weight %, about 0.01 to about 30% by weight %, about 0.01 to about 20% by weight %, about 0.01 to about 10% by weight or about 0.01 to about 5% by weight.

### Example 1

### Use of Tetramethyl Ammonium Dimethylphophinate in Polyamide 6

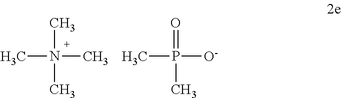

### Tetramethyl Ammonium Dimethylphophinate

Tetramethylammonium dimethylphosphate contains phosphorous 18.53%. Flame retardant is added to Polyamide 6 at 3% Phosphorous level. PA-6 pellets were dried at 80° C. for 24 h before mixing. PA-6 and flame retardants were mixed in a twin screw extruder (Thermoprism TSE 16 TC, Staffordshire, UK, L/D=24) at 100 r.p.m. and 230° C. The extrudate was cut into pellets, then successively, compression was molded at 230° C. into test bars for flammability testing.

### Example 2

### Use of Hydroxyl Ethyl Trimethylammonium Dimethylphosphinate in Epoxy Resin

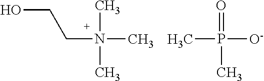

### Hydroxyethyl Trimethylammonium Dimethylphosphinate

Hydroxyethyl trimethylammonium dimethylphosphinate contains 15.71%. Diglycidyl ether of bisphenol A (DGEBA) was mixed with the flame retardant above at 3% phosphorous loading leve, followed by removal of air bubbles and moisture under vacuum. 4,4′-diaminodiphenyl sulfone was added as a curing agent with a stoichiometric amount. The mixture was cured at 130° C. for 2 h, 180° C. for 2 h, and finally postcured at 200° C. for 1 h. The obtained sample is cut for further characterizations.

### Example 3

### Use of Methyltrihexylphosphonium Ethylmethylphosphinate/Nanosilica in Polyactide

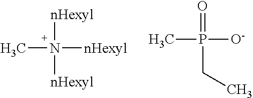

### Methyltrihexylphosphonium Ethylmethylphosphinate

PLA pellets were melt-compounded with fillers in a co-rotating twin screw extruder (Rondol Microlab 10 mm, L/D:20). Methyltrihexylphosphonium methylethylphosphinate is added at 3% Phosphorous level, and silica was 20% weight of phosphinate flame retardant. All constituents were first mechanically homogenized and fed continuously into the extruder main feeding zone using a screw type automatic feeder. Materials were dried under vacuum at 60° C. for 24 h prior to processing. Compounding was carried out with a temperature profile of 190-200-205-200-185° C. at 85 rpm screw speed. Specimens for characterization and testing were produced by lab scale injection (DSM 12 ml injection moulder, 190° C., 10 bar) and compression moulding (175° C., 100 bar) techniques.

### Example 4

### Use of Methyltrihexylphosphonium Methylethylphosphinate/Red Phosphors in PBT

Mix 30 weight percent of red phosphors into methyltrihexylphosphonium methylethylphosphinate to form a coated stabilized red phosphorous/phosphinate composite flame retardant. Flame retardant is added to Polyamide 6 at 3% Phosphorous level. PBT 6 pellets were dried at 80° C. for 24 h before mixing. PA-6 and flame retardants were mixed in a twin screw extruder (Thermoprism TSE 16 TC, Staffordshire, UK, L/D=24) at 100 r.p.m. and 230° C. The extrudate was cut into pellets, then successively, compression was molded at 230° C. into test bars for flammability testing.

EVA Copolymers:

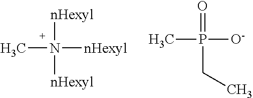

### Methyltrihexylphosphonium Ethylmethylphosphinate

Treatment of Ethylene-Vinyl Acetate (EVA) Copolymer with Methyltrihexylphosphonium Ethylmethylphosphinate:

EVA (80 g), methyltrihexylphosphonium ethylmethylphosphinate (3 g), low melting glass (5 g) and ATH (alumina trihydrate, 12 g) are mixed, melt blended in a Thermo Haake Rheomix with a screw speed of 60 rpm, and the mixing time is 15 min for each sample. The mixed samples are transferred to a mold and preheated at 180° C. for 5 min and then pressed at 15 MPa, followed by cooling the samples to room temperature while maintaining the pressure for 5 min.

Thermosets with ILs:

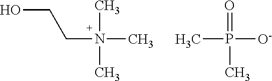

### Hydroxyethyl Trimethylammonium Dimethylphosphinate

Phenolic resin (80 g), hydroxyethyl trimethylammonium dimethylphosphinate (3 g), glass flake (5 g) and ATH (12 g) are mixed and compounded in a similar manner as described above. The polymers prepared according to the above procedure are found to have flame retardant properties.

### Thermoplastics Containing ILs:

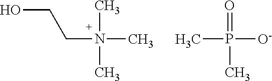

### Hydroxyethyl Trimethylammonium Dimethylphosphinate

Polybutylene terephthalate (90 g), hydroxyethyl trimethylammonium dimethylphosphinate (7 g), antimony trioxide (3 g) are mixed and extruded in a similar manner as described above. The polymers obtained according to the above procedure are found to have flame retardant properties.

Polycarbonate Polymers with IL:

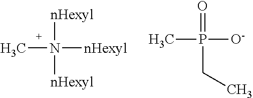

### Methyltrihexylphosphonium Ethylmethylphosphinate

Polycarbonate (90 g), methyltrihexylphosphonium ethylmethylphosphinate (5 g), silicon (3 g) and SnCl₂ (2 g) are mixed and extruded in a similar manner as described above. The polymers obtained according to the above procedure are found to have flame retardant properties.

Incorporation of Functionalized ILs into Polymers:

ILs monomers that have functional groups such as —Cl, —Br, —I, —CH═CH, —CH₂CH═CH, -epoxide, —OC(O)—CH═CH, —NCO, —C(O)Cl, —C(O)Br, —C(O)-imidazolyl, —CO₂(C₁-C₃)alkyl, —OC(O)CH₂C(O)CH₃ and —CH═CR₁₀CO₂(C₁-C₃)alkyl where R₁₀ is H or CH₃ may be polymerized into polymers to form polymers containing ILs. For example, ILs containing ethylene oxide groups may be polymerized by initiation with different agents such as postassium t-butoxide in a solvent, such as DMF.

Functionalized ILs Modified Rubber: The modified rubber may be a rubber phase polymer in a matrix containing functionalized ILs. The modified rubber may be prepared by polymerizing the functionalized IL with various rubbers. The modified rubber may be prepared by standard methods such as emulsion polymerization, suspension polymerization, bulk polymerization and by extrusion of a graft copolymer resin and a functionalized IL. The polymerization method employed may provide the modified rubber in about 50% to 90% by weight. In one embodiment, the functionalized ILs may be employed in about 1% to about 30% by weight with the rubber polymer in about 50% to about 95% by weight. Optionally, a copolymerizable polymer may be added in an amount of about 10% to about 30% by weight. Suitable polymers that may be employed include polybutadiene, poly(styrene-butadiene), poly(acrylonitrile-butadiene), isoprene rubbers; acrylic rubbers such as polybutyl acrylic acid; and ethylene-propylene rubbers and terpolymers of ethylene-propylene-diene (EPDM). Other copolymers that may be employed in the process include acrylonitrile, methacrylonitrile, acrylic acid, methacrylic acid, maleic anhydride and N-substituted maleimide. Other vinyl monomers may be used include α-methylstyrene and p-methylstyrene. Additional modified rubber resins may include acrylonitrile-butadiene-styrene (ABS), copolymer resins of acrylonitrile-acrylic rubber-styrene (AAS) and copolymer resins of acrylonitrile-ethylenepropylene rubber-styrene (AES).

In one example, 90 g of butadiene rubber latex powder, 5 g of a selected functionalized IL, 10 g of acrylonitrile and 150 g of deionized water are mixed together. To the mixture is added 0.4 g cumen hydroperoxide and 0.01 ferrous sulfate hydrate. The mixture is heated at about 75 to 85° C. for about 5 hours. The mixture is coagulated to obtain a modified rubber polystyrene resin in a powder form.

The flame retarding resins may also contain a filler for improving the physical and mechanical properties of the resins. In one aspect, the filler may include glass fibers, glass flakes, glass beads, glass powders, carbon fibers, carbon flakes, talc, mica, kaolin, montmorillonite, bentonite, sepiolite, xonotlite, clay, silica, titanium oxide, carbon black, organic fillers and combinations thereof.

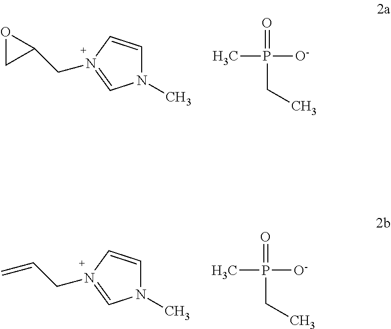

A resin containing ILs of the present application may be prepared as follows. The epoxide 2a in about 5% to 10% by weight, and an elastomer, about 80 to 95% by weight, containing at least acrylonitrile butadiene rubber containing a carboxyl group, and a hardening accelerator such as an organic phosphine or a phosphonium salt is combined and mixed. Optionally, aluminum hydroxide (0.1% to 5% by weight) and a filler (1% to about 5% by weight) containing talc may be added to the mixture. The mixture may be heated to a temperature of about 180° C. to 270° C. with agitation to form the desired resin.

A resin containing ILs of the present application may be prepared as follows. The epoxide 2b in about 5% to 10% by weight, and an elastomer, about 80 to 95% by weight, containing at least acrylonitrile butadiene rubber containing a carboxyl group, and a hardening accelerator such as an organic phosphine or a phosphonium salt is combined and mixed. Optionally, aluminum hydroxide (0.1% to 5% by weight) and a filler (1% to about 5% by weight) containing talc may be added to the mixture. The mixture may be heated to a temperature of about 180° C. to 270° C. with agitation to form the desired resin.

The resulting compositions provide a resin that is shown to be flame resistant and the resin has sufficient flexibility and may be used effectively as an electrical insulator. The resin compositions prepared according to the method may be used as adhesive insulation that is flame resistant or as printed circuit boards that are flame resistant.

Optionally, other resin additives, including polytrimethylene terephthalate based compounds such as polyethylene terephthalate, polybutylene terephthalate or nylon may be used as a resin additive in the above process to form various fibers and resins containing ILs that are flame resistant.

Incorporation of ILs with Clays:

The clay nanomaterials may be assembled with ILs using macro-scale assembly processes, such as the layer-by-layer (LBL) assembly methods. The method involves the alternating deposisiton of components from dilute solutions or discpersions on a suitable substrate, including inorganic molecular clusters, nanoparticles, nanotubes and nanowires, nanoplates, dendrimers and clay nanosheets. See for example, P. T. Hammond, Adv. Mater. 16 (2004) 1271. The method allows the formation of multi-functional thin films.

In one example, a mixture of an IL may be combined with a synthetic clay, such as hectorite (Laponite RD) to grow several hundred-nanometers thick films. In certain aspect, the clay may be a montmorillonite or a saponite. Standard layered silicates may also be employed as the clays. The resulting film provides a highly uniform surface coverage of the IL on the substrate, and may form clay multilayers. The nature of the final sheets may depend on various parameters employed, including the adsorption time, the concentration of the IL in the misture, the amount of clay in the dispersion and the pH of the aqueous solution. Thin films of clays and ILs may also be prepared using the traditional dipping method (or dip coating method) or the monolayer deposition method as known in the art. According to the methods, formation of individual nano sheets may be used as flexible fabric, wherein the fabrics are incorporated with flame retardants.

A flame retardant montmorillonite clay may be prepared by modification of a sodium montmorillonite clay with the epoxide 2a by an ion exchange reaction. Optionally, surface functionalization may be performed by grafting with an epoxide group containing a silane compound. The resulting flame retardant clay may be added to an epoxy resin and thermally cured to form various epoxy nanocomposites that are flame retardant.

Similarly, a flame retardant montmorillonite clay may be prepared by modification of a sodium montmorillonite clay with the IL 2b by an ion exchange reaction. The resulting flame retardant clay may be added to an epoxy resin and thermally cured to form various epoxy nanocomposites that are flame retardant.

Molding composition containing ILs may also be prepared. A mixture of a hardener for an epoxy resin, such as phenolic novolak resin, the epoxide 2a (about 5% to 10% by weight) and a quaternary organophosphonium salt for catalyzing a reaction between the epoxy resin, the hardener and the epoxide 2a. The resulting mixture may be heated to form the flame retardant molding composition that may be used for coating electronic devices.

Flame resistant polyurethanes may be prepared by mixing the epoxide 2a (about 500 g) with diglyme (500 mL) and about 0.5% KOH. The resulting mixture is heated under vacuum, and propylene oxide (495 g) is added. A polyether polyol from bisphenol A, diethanolamine, formaldehyde, propylene oxide and a glycerol-based polyether polyol is added. Mixing and curing the resulting composition at elevated temperatures provide a foam polyurethane having flame resistant properties.

The preparation of nanocomposites comprising ILs may be performed using various methods, including the solvent intercalation route that employs swelling the layered silicates in ILs to promote the diffusion of the ILs in the clay interlayer spacing, or the melt intercalation process which is based on polymer processing in the molten state such as extrusion. See for example, Sinha Ray S, Maiti P, Okamoto M, Yamada K, Ueda K. New polylactide/layered silicate nanocomposites. 1. Preparation, characterization and properties. Macromolecules 2002; 35:3104-10; and Tanoue S, Hasook A, Iemoto Y, Unryu T. Preparation of poly(lactic acid)/poly(ethylene glycol)/organoclay nanocomposites by melt compounding. Polym Compos 2006; 27:256-63, which is incorporate herein in their entirety.

Compounding Treatment of Polyoxymethylene with 1-Butyl-3-methylimidazolium ethylmethyl-phosphinate and aluminum hydroxide:

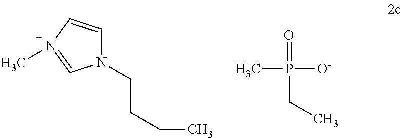

Aluminum hydroxide power (5 gm) is premixed with ionic liquid 2c (95 gm), then mixed with polyoxymethylene pellets (900 gm), and then melt-blended by a twin screw extruder at 170-185° C. with a screw rotation speed of 150-180 rpm. The extruded pellets are molded into standard bars for combustibility and mechanical performance tests through an injection-molding machine with a plasticizing temperature of 170-195° C.

Compounding treatment of polypropylene with intumescent flame retarding system using triethylmethylphosphonium ethylmethyl phosphinate ≧97.0% (CH).

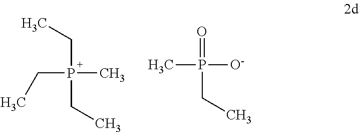

A mixture of ionic liquid 2d (2 gm), pentaerythritol (carbonization agent) (5 gm) and melamine (3 gm) are premixed and then mixed with polypropylene (90 gm). The mixture is then melt-blended by a twin screw extruder at 200° C. with a screw rotation speed of 150-180 rpm. The extruded pellets are molded into standard bars for combustibility and mechanical performance tests through an injection-molding machine with a plasticizing temperature of 230° C.

Treatment of PVC Using IL 2d with Antimony Trioxide:

A mixture of IL 2d (5 gm) and antimony trioxide (2 gm) are premixed, and then mixed with polyvinyl chloride resin (93 gm). The mixture is blended and molded into required shape and dimension in a similar manner as disclosed above.

### Treatment of PVC Using IL 2f and Traditional Brominated Flame Retardant

### Tetrabromobisphenol A:

A mixture of IL 2f (3 gm), TBBPA (3 gm) are premixed, and mixed with PVC resin (94 gm). The mixture is blended and molded into required shape and dimension in a similar manner as disclosed above.

Treatment of high density polyethylene (HDPE) with ionic tributylmethylamonium diethylphosphinate liquid modified clay:

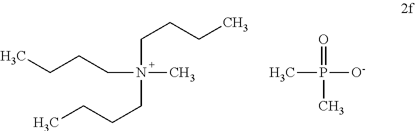

The surface of the clay is modified with ionic liquids through ion exchange reaction. HDPE (97 gm) and IL 2f modified clay (3 gm) are mixed, melt blended in ThermoHaake Rheomix with a screw speed of 60 rpm, and the mixing time for each sample is 15 min. The mixed samples are transferred to a mold and preheated at 180° C. for 5 min and then pressed at 15 MPa followed by cooling them to room temperature while maintaining the pressure for 5 min.

Treatment of polyimide 6 with ionic liquid/carbon nanotubes or ionic liquid/carbon nanofibers using methyltetrabutylammonium methyl-n-hexylphosphinate 2g:

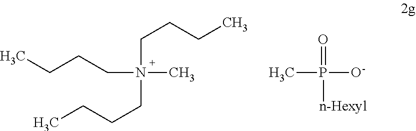

A mixture of IL 2g (3 gm) and carbon nanotubes or nanofibers (2 gm) are premixed, and then melt-blended and molded in a similar manner as disclosed above.

### Treatment of Polystyrene Via In-Situ Polymerization Method:

A mixture of styrene (95 g), IL 2c (5 g), AIBN (0.2 g) is prepared. The mixture is stirred magnetically under nitrogen at room temperature until a homogenous mixture is formed. The mixture is heated at 90° C. for pre-polymerization until a critical viscosity of the mixture is reached. The mixture was then transferred to an oven and kept isothermally at 60° C. for 24 h and then at 80° C. for 20 h. A copolymer containing IL is obtained.

### Application of IL Flame Retardants as a Components of Coating or Paint Layers:

Ionic liquid flame retardant 2d (5 g) is mixed with 250 ml of paint and coating materials. The resulting material is used as a heat resistant or flame resistant coating on potentially flammable surfaces. Heating of the coated materials shows that the materials are heat resistant or flame resistant to about 455° C. The coating composition may include those formulated form modified epoxy ester resin coating, modified silicone-alkyd resin coating, specially modified silicone acrylic resin and modified silicone acrylic.

The polymers containing the ILs prepared according to the methods above, for example provides significantly improved UL94 test characteristics.

### Flame Retarding Finishing of Cotton Textile Materials:

Flammable fabrics may be treated to minimize burning hazards. One such treatment involve fiber copolymerization wherein one or more fiber monomers that are flammable are combined and copolymerized with fire retardant fibers, resulting in improved properties of the fabric. In one aspect, the fire or flame retardant fibers are treated or impregnated with ionic liquids (IL) of the present application. In another aspect, the IL may be introduced onto the fibers or fabrics using chemical post treatment method by coating the fabric or by the introduction of the IL into the fabric by impregnating the fabric with the IL during the dyeing of the fabric. According to these methods, the IL are bound to the fabric and do not readily migrate from the fabric into the environment.

Cationic softening agents—such as one or more of polyolefins, modified polyolefins, ethoxylated alcohols, ethoxylated ester oils, alkyl glycerides, fatty acid derivatives, fatty imidazolines, paraffins, halogenated waxes, and halogenated esters—are used instead to impart softness to the treated fabric. A single softening agent or a combination of different softening agents may be used.

Stain and water repellant agents of the present application may include fluoropolymers, waxes, silicones and polysiloxanes, hydrophobic resins, commercially available fluoropolymers and combinations thereof.

Coating of the ionic liquid flame retarding composition according to the present method allows the coating composition to retain its properties without flaking or melting even after exposure to heat or fire. The coating composition also provides fabrics that are durable for multiple launderings.

In certain embodiments for the use of the flame retardants on fabrics, softeners may be used and may include polydimethylsiloxane, amino siloxane and quaternary silicone softeners.

A finishing aqueous solution containing 7% by weight IL flame retardant 2a is prepared. The cotton fleece is first immersed in the solution, then passed through a laboratory padder with two dips and two nips, dried at 90° C. for 3 min 45 s, and finally cured in a Mathis oven at 170° C. for 4 min.

### Flame Retarding Finishing of Leather Materials:

A finishing aqueous solution containing 7% by weight flame retardant 2d is prepared. The finishing of leather can be done in a similar manner as used in textile finishing.

### Flame Retarding Treatment of Wood:

An aqueous impregnation solution is prepared containing 7% by weight IL 2d. Test panels are prepared on A. angustifolia. The impregnations are carried out at 201° C. in a vertical Pressure vessel of 251 capacity, provided with a vacuum pump and an air compressor. In all the cases, the vessel is loaded with the test panels to be impregnated; then the pressure is reduced by 400 mmHg for 30 min to remove air and vapor from the wood cells. The impregnants are added at the reduced pressure. After about 5 minutes, the pressure is gradually increased until a final pressure of 4780 mmHg (6.5 kgcm²) to facilitate the penetration; this stage lasts for 120 min. Next, the pressure is reduced to a light vacuum (approximately 50 mmHg for 10 min) to eliminate the excess of solution. Finally, the test panels are removed and rinsed with distilled water.

### Flame Treatment of Paper:

An aqueous finishing solution containing 7% by weight IL 2d is prepared. The paper is treated by soaking the samples in the finishing solution for 10 min. The excess solution is removed by pressing the samples between two roll mills of a manually operated wringer.

### Reduction of Melt Viscosity of Polymers and Plastics:

The IL of the present application may be added to various polymers or plastics to reduce the melt viscosity of the polymers or plastics in the processing of the polymers or plastics. Decreasing the viscosity during processing results in the lowering the processing temperatures, provides shorter processing or cycle times, lowering processing pressures among other processing advantages. The resulting polymers or plastics may be obtained with higher crystallinity, more ordered or well-defined morphologies, and may provide products with better oxidative resistance or stability, better US stability and improved barrier to gas properties, such as for PET bottle applications. In one example, the IL employed for reducing the melt viscosity are compounded PBT and PET. In another example, the IL employed is PBT. In another example, the IL employed is PET.

Viscosity of polymers (or plastics) may be characterized using capillary rheometers or rotational shear viscometers. For methods using rotational shear visocometers, either a true rotational motion or an oscillation may be imparted to the melt, imparting a true rotational motion or an oscilation to the melt, resulting to information of either the steady shear viscositu of the complex viscosity, μ*. See for example, W. P. Cox and E. H. Merz, J. Polym. Sci. 28, 619 (1958).

### Reduction in Viscosity of PMMA:

The addition of a phosphinate ionic liquid 2e (about 3% wt/wt) to a polymer, such as polymethylmethacrylate (PMMA) at about 240 C provides a significant drop in the initial Newtonian viscosity (ω=0) from about 130,000 Poises (13,000 pa-s) to about 20,000 Posies (2,000 Pa-s), which is more than six folds.

### Improvement of Tensile Properties of Polystyrene:

The addition of a phosphinate ionic liquid 2f (about 3% wt/wt) to an amorphous polymer, such as polystyrene, provides significant improvements of the tensile properties of the melt samples. For example, improvements of the modulus of elasticity is observed for up to about 120% (normal polystyrene modulus of about 12,500 kg/cm² versus polystyrene with the added IL at about 22,500 kg/cm²), and at about 90% or more for the breaking stress (normal polystyrene of about 450 to 520 kg/cm² versus polystyrene with the added IL at about 850 kg/cm²) determined by the area under the measured stress-strain curve) of polystyrene. The energy to break for a normal polystyrene sample is about 7 to 12 kg-cm, whereas the energy to break for the polystyrene with the added IL is about 15 to 25 kg-cm, or an improvement of up to 150%.

### Improvement in Crystalline Structure and Uniform Melt Properties:

5% Tetrabutylphosphonium dibutylphosphosphinate (TBPDBP) and PBT from Aldrich were mixed at 210° C. using a Haak microcompounder. The torque was measured and determined to change from 500 to 0; and a liquid was obtained. For control PBT sample, the torque changed from 500 to 230, without any further reduction, indicating a uniform melt was obtained.

In performing the experiment, when the polymer melt cooled down to about room temperature, small angel X-ray diffraction experiments of the control and treated samples were conducted. The X-Ray profiles revealed that the treated sample were more crystalline in structure than the untreated samples.

5% tetrabutylphosphonium bis(2,4,4-trimethylpentyl)phosphinate (TBPDOP) and PET from Aldrich were mixed at 210° C. using a Haak microcompunder, and the torque of the mixtures were determined. The torque was changed from 500 to 0, resulting in the formation of a liquid mixture.

### Wild Fire Protection:

Small ginkgo tree branch samples of approximately equivalent size were taken from University of the Colorado at Boulder campus. All samples were oven dried at 120° C. for 24 hours. Branch samples were soaked in the methyltetrabutylammonium methyl-n-hexylphosphinate 2g flame retardant solution for 5 seconds. Then the samples were taken out of the solution, and hung in still air for 20 minutes to remove excess retardant solution. The samples were then further dried for another 24 hours at room temperature. Controlled sample using pure water treatment were prepared and dried in the same way.

### Flammability Test

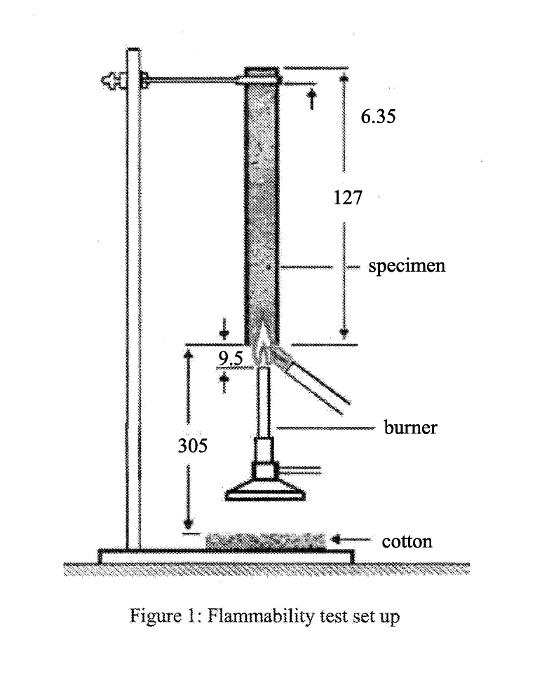

UL 94V, a simple test of vertical combustion, is employed for flammability testing. The corresponding experimental device is shown in FIG. 1. The burner was controlled to produce a blue flame with a 20 mm high central cone and a power of 50 W. The flame was applied to the bottom of the sample and the top of the burner was located at 10 mm from the bottom edge of the sample. The flame is applied for 10 seconds and removed. The after flame time t1 (the time required for the flame to extinguish) is noted. After extinction, the flame is applied for another 10 seconds. The after flame time t2 is noted, together with the afterglow time t3 (the time required for the fire glow to disappear).

TABLE 1
After flame times of treated and control samples

| After Flame Time | IL (2f) Treated Sample | Control Sample |
|---|---|---|
| T1 | 3 s | 6 s |
| T2 | 3 s | 7 s |
| T3 | 1 s | 324 s |

As is apparent from these experiments, the after flame time of samples treated with 2f is significantly shorter than those of the control samples, which clearly show the capacity and efficiency of ammonium phosphinate ionic liquids as effective flame retardants. Flame Retardants for Fighting Forest Fires:

50 weight % mixture of IL 2a is prepared and sprayed in a controlled forest area containing evergreens such as pines, spruces and fir trees and shrubs for demonstrating the effectiveness of the use of IL for fire protection for wild forest fires. The controlled burn area was ignited, allowed to burn for about 3 minutes, and the IL prepared according to the procedures provided herein were sprayed over the fire. The active fire was extinguished almost immediately and the unburned evergreens were protected from any residual flames. In one variation of the procedure, the IL may be mixed with water and high viscosity gum thickeners to form the IL flame retardant. Optionally, colorant such as an off-white color or red iron oxide may be added.

In another example, the IL may be combined with ammonium polyphosphate, diammonium phosphate, monoammonium phosphate, attapulgus clay, guar gum or a derivative of guar gum, and combinations thereof to form the IL composition for treating forest fires. In another example, the IL of the present application may be mixed or combined with commercial fire or flame retardants such as PHOS-CHEK D75 to provide a highly effective fire retardant composition. Such high viscosity composition provides accurate drop characteristics and highly effective penetration through forest canopy.

While a number of exemplary embodiments, aspects and variations have been provided herein, those of skill in the art will recognize certain modifications, permutations, additions and combinations and certain sub-combinations of the embodiments, aspects and variations. It is intended that the following claims are interpreted to include all such modifications, permutations, additions and combinations and certain sub-combinations of the embodiments, aspects and variations are within their scope.

What is claimed is:

1. A method for preparing a flame retardant material comprising contacting or formulating the material with a flame retarding composition comprising an ionic liquid compound of the formula 1: 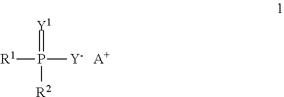
wherein:
Y and Y¹ are each independently selected from O or S;
R¹ and R² are each independently selected from the group consisting of hydrogen, (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group, each of which may be unsubstituted or substituted with one or two halo, —NO₂, CF₃—, CF₃O—, CH₃O—, —CO₂H, —NH₂, —OH, —SH, —NHCH₃, —N(CH₃)₂, —CN, —SMe, —SO₃H, —CH═CH₂, —CH₂CH═CH₂, —P((C₁-C₅)alkyl)₂ and —P(O)(OEt)₂, or mixtures of the substituents;
A⁺ is a cation selected from the group consisting of an ammonium, imidazolium, guanidinium, pyridinium, pyridazinium, 1,2,4-triazolium, triazine, sulfonium, phosphazenium and phosphonium cation; and
optionally, wherein the A⁺ is a cation as defined above that is covalently bonded to a polymer.

2. The method according to claim 1, wherein A⁺ is an ammonium cation of the formula 2: 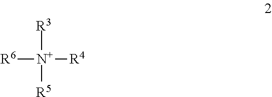
wherein R³, R⁴, R⁵ and R⁶ are each independently a bond or are selected from the group consisting of hydrogen, —CF₃, —C₂F₅, —C₃F₇, —C₄F₉, (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group, each of which may be unsubstituted or substituted with one or two —Cl, —Br, —I, —NO₂, CF₃O—, CH₃O—, —CO₂H, —NH₂, —OH, —SH, —NHCH₃, —N(CH₃)₂, —CN, —SMe, —SO₃H, —CF₃, —C₂F₅, —C₃F₇, —C₄F₉, —CH═CH, —CH₂CH═CH, -epoxide, —OC(O)—CH═CH, —NCO, —C(O)Cl, —C(O)Br, —C(O)-imidazolyl, —CO₂(C₁-C₃)alkyl, —P((C₁-C₅)alkyl)₂, —P(O)(OEt)₂, —OC(O)CH₂C(O)CH₃ and —CH═CR₁₀CO₂(C₁-C₃)alkyl, where R₁₀ is H or CH₃, or mixtures of the two substituents.

3. The method of claim 2, wherein N⁺ together with R³, R⁴, R⁵ and R⁶ form a cation selected from the group consisting of ammonium, imidazolium, guanidinium, pyridinium, pyridazinium and 1,2,4-triazolium, each of which is unsubstituted or substituted by one or two substituents selected from the group consisting of —Cl, —Br, —I, —NO₂, CF₃O—, CH₃O—, —CO₂H, —NH₂, —OH, —SH, —NHCH₃, —N(CH₃)₂, —CN, —SMe, —SO₃H, —CF₃, —C₂F₅, —C₃F₇, —C₄F₉, —CH═CH, —CH₂CH═CH, -epoxide, —OC(O)—CH═CH, —NCO, —C(O)Cl, —C(O)Br, —C(O)— imidazolyl, —CO₂(C₁-C₃)alkyl, —P((C₁-C₅)alkyl)₂, —P(O)(OEt)₂, —OC(O)CH₂C(O)CH₃ and —CH═CR₁₀CO₂(C₁-C₃)alkyl, where R₁₀ is H or CH₃, or mixtures of the two substituents.

4. The method of claim 2, wherein the compound of the formula 2 is selected from the group consisting of: 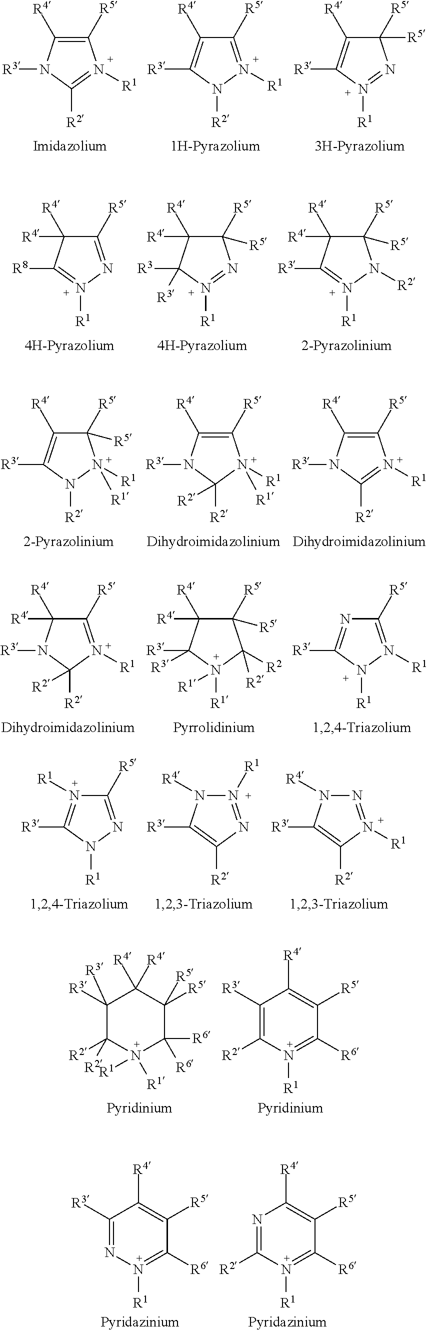 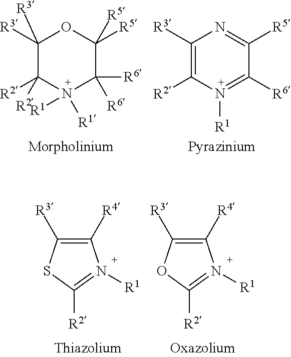
wherein:
each R¹, R^{1′}, R², R^{2′}, R³, R^{3′}, R⁴, R^{4′}, R⁵, R^{5′}, R⁶ and R^{6′} is independently selected from the group consisting of hydrogen, (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group, each of which may be unsubstituted or substituted with one or two halo, —NO₂, CF₃—, CF₃O—, CH₃O—, —CO₂H, —NH₂, —OH, —SH, —NHCH₃, —N(CH₃)₂, —CN, —SMe, —SO₃H, —CH═CH₂, —CH₂CH═CH₂, —P((C₁-C₅)alkyl)₂ and —P(O)(OEt)₂, or mixtures of the two substituents.

5. The method of claim 4, wherein:
each R¹, R^{1′}, R², R^{2′}, R³, R^{3′}, R⁴, R^{4′}, R⁵, R^{5′}, R⁶ and R^{6′} is independently selected from the group consisting of hydrogen, —CH₃, —CF₃, —C₂F₅, —C₃F₇, —C₄F₉, unsubstituted (C₂-C₁₀)alkyl, —CH₂phenyl and (C₁-C₁₀)alkyl substituted with one —Cl, —Br, —I, —CF₃, —C₂F₅, —C₃F₇, —C₄F₉, —CH═CH, —CH₂CH═CH, —CH₂CHCH, -ethylene oxide, —OC(O)—CH═CH, —NCO, —C(O)Cl, —C(O)Br, —C(O)-imidazolyl and —CO₂(C₁-C₃)alkyl.

6. The method according to claim 1 wherein the compound is of the formula 1a: 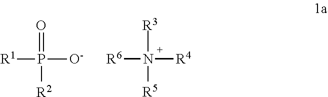
wherein:
R¹ and R² are each independently selected from the group consisting of (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group, each of which may be unsubstituted or substituted with one or two halo, —NO₂, CF₃—, CF₃O—, CH₃O—, —CO₂H, —NH₂, —OH, —SH, —NHCH₃, —N(CH₃)₂, —CN, —SMe, —SO₃H, —CH═CH₂, —CH₂CH═CH₂, —P((C₁-C₅)alkyl)₂ and —P(O)(OEt)₂, or mixtures of the substituents; and
wherein R³, R⁴, R⁵ and R⁶ are each independently a bond or are selected from the group consisting of hydrogen, —CF₃, —C₂F₅, —C₃F₇, —C₄F₉, (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group, each of which may be unsubstituted or substituted with one or two —Cl, —Br, —I, —NO₂, CF₃O—, CH₃O—, —CO₂H, —NH₂, —OH, —SH, —NHCH₃, —N(CH₃)₂, —CN, —SMe, —SO₃H, —CF₃, —C₂F₅, —C₃F₇, —C₄F₉, —CH═CH, —CH₂CH═CH, -epoxide, —OC(O)—CH═CH, —NCO, —C(O)Cl, —C(O)Br, —C(O)-imidazolyl, —CO₂(C₁-C₃)alkyl, —P((C₁-C₅)alkyl)₂, —P(O)(OEt)₂, —OC(O)CH₂C(O)CH₃ and —CH═CR₁₀CO₂(C₁-C₃)alkyl, where R₁₀ is H or CH₃, or mixtures of the two substituents; or
wherein N⁺ together with R³, R⁴, R⁵ and R⁶ form a cation selected from the group consisting of ammonium, imidazolium, guanidinium, pyridinium, pyridazinium and 1,2,4-triazolium, each of which is unsubstituted or substituted by one or two substituents selected from the group consisting of —Cl, —Br, —I, —NO₂, CF₃O—, CH₃O—, —CO₂H, —NH₂, —OH, —SH, —NHCH₃, —N(CH₃)₂, —CN, —SMe, —SO₃H, —CF₃, —C₂F₅, —C₃F₇, —C₄F₉, —CH═CH, —CH₂CH═CH, -epoxide, —OC(O)—CH═CH, —NCO, —C(O)Cl, —C(O)Br, —C(O)-imidazolyl, —CO₂(C₁-C₃)alkyl, —P((C₁-C₅)alkyl)₂, —P(O)(OEt)₂, —OC(O)CH₂C(O)CH₃ and —CH═CR₁₀CO₂(C₁-C₃)alkyl, where R₁₀ is H or CH₃, or mixtures of the two substituents.

7. The method according to claim 1 wherein the compound is of the formula 1a:
wherein at least one of R₁, R₂, R₃, R₄, R₅ or R₆ is selected from the group consisting of —CF₃, —C₂F₅, —C₃F₇, —C₄F₉, unsubstituted (C₁-C₁₀)alkyl, and (C₁-C₁₀)alkyl substituted with one —Cl, —Br, —I, —CF₃, —C₂F₅, —C₃F₇, —C₄F₉, —CH═CH, —CH₂CH═CH, —CH₂CHCH, -ethylene oxide, —OC(O)—CH═CH, —NCO, —C(O)Cl, —C(O)Br, —C(O)-imidazolyl, —CO₂(C₁-C₃)alkyl, —OC(O)CH₂C(O)CH₃ and —CH═CR₁₀CO₂(C₁-C₃)alkyl, where R₁₀ is H or CH₃.

8. The method according to claim 1 wherein the compound is of the formula:

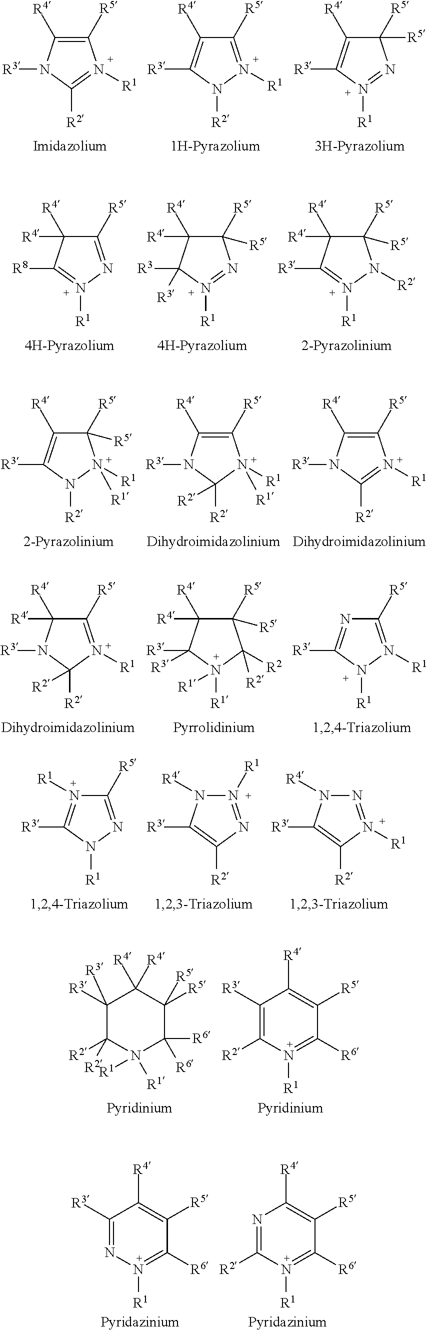

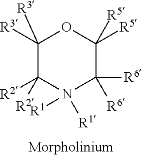

9. The method of claim 1, wherein the method further comprises contacting or formulating the ionic liquid with a second different ionic liquid.

10. The method of claim 1, wherein the method further comprises contacting or formulating the material with an ionic liquid in combination with an agent selected from the group consisting of a mineral flame retardant, a halogenated flame retardant, a phosphorus based flame retardant, a nitrogen based flame retardant, a silicon based flame retardants and nanometric particles, and combinations thereof.

11. The method of claim 1, wherein the material is selected from the group consisting of textile, resin, plastic, rubber, leather, paper and wood products.

12. A flame retardant or flame resistant material comprising an effective amount of a flame retardant composition comprising an ionic liquid compound of the formula 1: 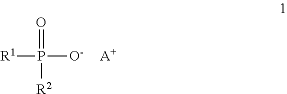
wherein:
R¹ and R² are each independently selected from the group consisting of hydrogen, (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group, each of which may be unsubstituted or substituted with one or two halo, —NO₂, CF₃—, CF₃O—, CH₃O—, —CO₂H, —NH₂, —OH, —SH, —NHCH₃, —N(CH₃)₂, —CN, —SMe, —SO₃H, —CH═CH₂, —CH₂CH═CH₂, —P((C₁-C₅)alkyl)₂ and —P(O)(OEt)₂, or mixtures of the substituents;
A⁺ is a cation selected from the group consisting of an ammonium, imidazolium, guanidinium, pyridinium, pyridazinium, 1,2,4-triazolium, triazine, sulfonium, phosphazenium and phosphonium cation; and
optionally, wherein the A⁺ is a cation as defined above that is covalently bonded to a polymer.

14. The flame retardant or resistant material of claim 13, wherein the material is selected from the group consisting of textile, fabric, resin, plastic, rubber, leather, paper and wood products, and surface coating formulations.

15. The flame retardant or resistant fabric of claim 14, wherein the fabric comprises natural fibers or synthetic fibers selected from the group consisting of nylon, polyacrylates, polyesters and polyamides and combinations thereof.

16. The flame retardant or flame resistant material of claim 13, wherein the material is a polymer selected from the group consisting of a thermoplastic, phenolics, polycarbonates, polyurethanes, polyesters, polyethylene, polypropylene, polyacrylic acid, butadiene/acrylonitrile-acrylonitrile/styrene copolymers, ethylene-vinyl acetate copolymers, polyamides, acrylic resisn and epoxy resins.

17. A method for reducing the melt viscosity of a polymer during the processing of the polymer comprising adding a composition comprising an ionic liquid compound with the polymer before processing the polymer, wherein:
a) the ionic liquid compound is of the formula 1: 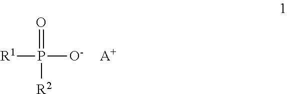
wherein:
R¹ and R² are each independently selected from the group consisting of hydrogen, (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group, each of which may be unsubstituted or substituted with one or two halo, —NO₂, CF₃—, CF₃O—, CH₃O—, —CO₂H, —NH₂, —OH, —SH, —NHCH₃, —N(CH₃)₂, —CN, —SMe, —SO₃H, —CH═CH₂, —CH₂CH═CH₂, —P((C₁-C₅)alkyl)₂ and —P(O)(OEt)₂, or mixtures of the substituents;
A⁺ is a cation selected from the group consisting of an ammonium, imidazolium, guanidinium, pyridinium, pyridazinium, 1,2,4-triazolium, triazine, sulfonium, phosphazenium and phosphonium cation; and
optionally, wherein the A⁺ is a cation as defined above that is covalently bonded to a polymer; or
b) the ionic liquid compound is of the formula 1, wherein:
A⁺ is an ammonium cation of the formula 2: 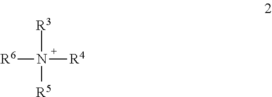
wherein R³, R⁴, R⁵ and R⁶ are each independently a bond or are selected from the group consisting of hydrogen, —CF₃, —C₂F₅, —C₃F₇, —C₄F₉, (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group, each of which may be unsubstituted or substituted with one or two —Cl, —Br, —I, —NO₂, CF₃O—, CH₃O—, —CO₂H, —NH₂, —OH, —SH, —NHCH₃, —N(CH₃)₂, —CN, —SMe, —SO₃H, —CF₃, —C₂F₅, —C₃F₇, —C₄F₉, —CH═CH, —CH₂CH═CH, -epoxide, —OC(O)—CH═CH, —NCO, —C(O)Cl, —C(O)Br, —C(O)-imidazolyl, —CO₂(C₁-C₃)alkyl, —P((C₁-C₅)alkyl)₂, —P(O)(OEt)₂, —OC(O)CH₂C(O)CH₃ and —CH═CR₁₀CO₂(C₁-C₃)alkyl, where R₁₀ is H or CH₃, or mixtures of the two substituents; or
c) the ionic liquid compound is of the formula 2, wherein:
N⁺ together with R³, R⁴, R⁵ and R⁶ form a cation selected from the group consisting of ammonium, imidazolium, guanidinium, pyridinium, pyridazinium and 1,2,4-triazolium, each of which is unsubstituted or substituted by one or two substituents selected from the group consisting of —Cl, —Br, —I, —NO₂, CF₃O—, CH₃O—, —CO₂H, —NH₂, —OH, —SH, —NHCH₃, —N(CH₃)₂, —CN, —SMe, —SO₃H, —CF₃, —C₂F₅, —C₃F₇, —C₄F₉, —CH═CH, —CH₂CH═CH, -epoxide, —OC(O)—CH═CH, —NCO, —C(O)Cl, —C(O)Br, —C(O)-imidazolyl, —CO₂(C₁-C₃)alkyl, —P((C₁-C₅)alkyl)₂, —P(O)(OEt)₂, —OC(O)CH₂C(O)CH₃ and —CH═CR₁₀CO₂(C₁-C₃)alkyl, where R₁₀ is H or CH₃, or mixtures of the two substituents; or
d) the ionic liquid compound of the formula 2 is selected from the group consisting of: 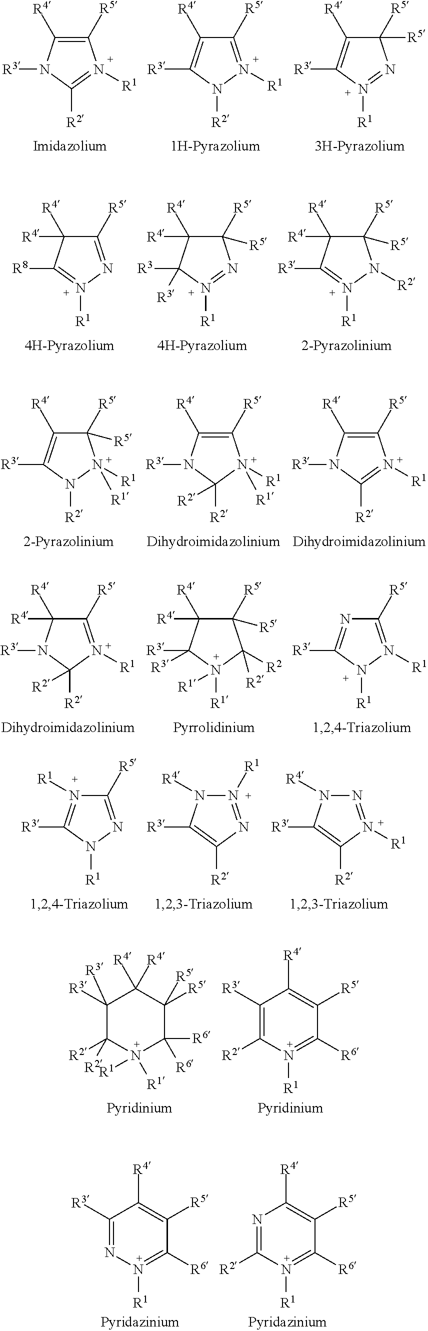 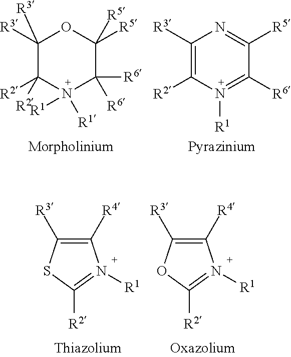
wherein:
each R¹, R^{1′}, R², R^{2′}, R³, R^{3′}, R⁴, R^{4′}, R⁵, R^{5′}, R⁶ and R^{6′} is independently selected from the group consisting of hydrogen, (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group, each of which may be unsubstituted or substituted with one or two halo, —NO₂, CF₃—, CF₃O—, CH₃O—, —CO₂H, —NH₂, —OH, —SH, —NHCH₃, —N(CH₃)₂, —CN, —SMe, —SO₃H, —CH═CH₂, —CH₂CH═CH₂, —P((C₁-C₅)alkyl)₂ and —P(O)(OEt)₂, or mixtures of the two substituents; or
e) wherein each R¹, R^{1′}, R², R^{2′}, R³, R^{3′}, R⁴, R^{4′}, R⁵, R^{5′}, R⁶ and R^{6′} is independently selected from the group consisting of hydrogen, —CH₃, —CF₃, —C₂F₅, —C₃F₇, —C₄F₉, unsubstituted (C₂-C₁₀)alkyl, —CH₂phenyl and (C₁-C₁₀)alkyl substituted with one —Cl, —Br, —I, —CF₃, —C₂F₅, —C₃F₇, —C₄F₉, —CH═CH, —CH₂CH═CH, —CH₂CHCH, -ethylene oxide, —OC(O)—CH═CH, —NCO, —C(O)Cl, —C(O)Br, —C(O)-imidazolyl and —CO₂(C₁-C₃)alkyl; or
f) wherein the compound is of the formula 1a: 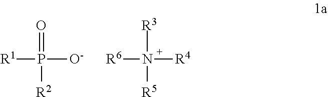
wherein:
R¹ and R² are each independently selected from the group consisting of (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group, each of which may be unsubstituted or substituted with one or two halo, —NO₂, CF₃—, CF₃O—, CH₃O—, —CO₂H, —NH₂, —OH, —SH, —NHCH₃, —N(CH₃)₂, —CN, -SMe, —SO₃H, —CH═CH₂, —CH₂CH═CH₂, —P((C₁-C₅)alkyl)₂ and —P(O)(OEt)₂, or mixtures of the substituents; and
wherein R³, R⁴, R⁵ and R⁶ are each independently a bond or are selected from the group consisting of hydrogen, —CF₃, —C₂F₅, —C₃F₇, —C₄₉, (C₁-C₂₀)alkyl, aryl, (C₃-C₁₀)heterocyclyl, (C₃-C₁₀)cycloalkyl, (C₃-C₁₀)heterocyclyl(C₁-C₈)alkyl, aryl(C₁-C₈)alkyl, heteroaryl and heteroaryl(C₁-C₈)alkyl group, each of which may be unsubstituted or substituted with one or two —Cl, —Br, —I, —NO₂, CF₃O—, CH₃O—, —CO₂H, —NH₂, —OH, —SH, —NHCH₃, —N(CH₃)₂, —CN, —SMe, —SO₃H, —CF₃, —C₂F₅, —C₃F₇, —C₄F₉, —CH═CH, —CH₂CH═CH, -epoxide, —OC(O)—CH═CH, —NCO, —C(O)Cl, —C(O)Br, —C(O)-imidazolyl, —CO₂(C₁-C₃)alkyl, —P((C₁-C₅)alkyl)₂, —P(O)(OEt)₂, —OC(O)CH₂C(O)CH₃ and —CH═CR₁₀CO₂(C₁-C₃)alkyl, where R₁₀ is H or CH₃, or mixtures of the two substituents; or
wherein N⁺ together with R³, R⁴, R⁵ and R⁶ form a cation selected from the group consisting of ammonium, imidazolium, guanidinium, pyridinium, pyridazinium and 1,2,4-triazolium, each of which is unsubstituted or substituted by one or two substituents selected from the group consisting of —Cl, —Br, —I, —NO₂, CF₃O—, CH₃O—, —CO₂H, —NH₂, —OH, —SH, —NHCH₃, —N(CH₃)₂, —CN, —SMe, —SO₃H, —CF₃, —C₂F₅, —C₃F₇, —C₄F₉, —CH═CH, —CH₂CH═CH, -epoxide, —OC(O)—CH═CH, —NCO, —C(O)Cl, —C(O)Br, —C(O)-imidazolyl, —CO₂(C₁-C₃)alkyl, —P((C₁—O₅)alkyl)₂, —P(O)(OEt)₂, —OC(O)CH₂C(O)CH₃ and —CH═CR₁₀CO₂(C₁-C₃)alkyl, where R₁₀ is H or CH₃, or mixtures of the two substituents; or
g) wherein the compound is of the formula 1a:
wherein at least one of R₁, R₂, R₃, R₄, R₅ or R₆ is selected from the group consisting of —CF₃, —C₂F₅, —C₃F₇, —C₄F₉, unsubstituted (C₁-C₁₀)alkyl, and (C₁-C₁₀)alkyl substituted with one —Cl, —Br, —I, —CF₃, —C₂F₅, —C₃F₇, —C₄F₉, —CH═CH, —CH₂CH═CH, —CH₂CHCH, -ethylene oxide, —OC(O)—CH═CH, —NCO, —C(O)Cl, —C(O)Br, —C(O)-imidazolyl, —CO₂(C₁-C₃)alkyl, —OC(O)CH₂C(O)CH₃ and —CH═CR₁₀CO₂(C₁-C₃)alkyl, where R₁₀ is H or CH₃; or
h) wherein the compound is of the formula:

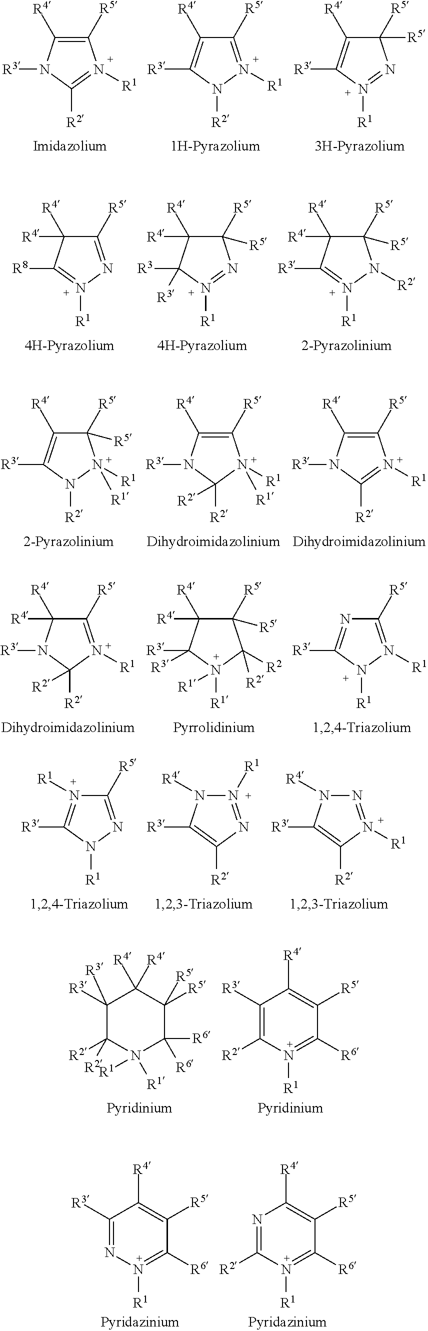

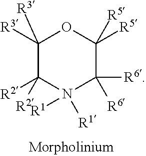

18. The method of claim 17, wherein the polymer is selected from the group consisting of polypropylene, polystyrene, polyethyleneterephthalate (PET), polycarbonate, thermoplastic, phenolics, polycarbonates, polyurethanes, polyesters, polyethylene, polypropylene, polyacrylic acid, butadiene/acrylonitrile-acrylonitrile/styrene copolymers, ethylene-vinyl acetate copolymers, polyamides, acrylic resins and epoxy resins.

19. The method of claim 17, wherein the ionic liquid compound comprises 0.01% wt/wt, 0.02% wt/wt, 0.03% wt/wt, 0.05% wt/wt, 0.1% wt/wt, 0.5% wt/wt, 1.0% wt/wt, 1.5% wt/wt, 2.0% wt/wt, 2.5% wt/wt, 3% wt/wt, 5% wt/wt, 10% wt/wt, 20% wt/wt, 30% wt/wt, 40% wt/wt, 50% wt/wt or more of the polymer.

20. The method of claim 17, wherein the processing of the polymer is selected from the group consisting of injection molding, extrusion, compression molding and thermomolding.
